(19) United States
(12) Patent Application Publication
(10) Pub. No.: US 2017/0085731 A1
(43) Pub. Date: Mar. 23, 2017

(54) IMAGE PROCESSING APPARATUS, DISPLAY CONTROL METHOD IN THE IMAGE PROCESSING APPARATUS, AND STORAGE MEDIUM

(71) Applicant: CANON KABUSHIKI KAISHA, Tokyo (JP)

(72) Inventor: Masao Akuzawa, Tokyo (JP)

(21) Appl. No.: 15/261,189

(22) Filed: Sep. 9, 2016

(30) Foreign Application Priority Data
Sep. 17, 2015 (JP) 2015-184320

(51) Int. Cl. H04N 1/00; G06F 3/0482

(52) U.S. Cl. CPC H04N 1/00506; G06F 3/0482; H04N 1/00411; H04N 1/00474; H04N 2201/0094

(57) ABSTRACT

A display control method in an image processing apparatus capable of executing a plurality of functions and an image processing apparatus capable of executing a plurality of functions are provided. The image processing apparatus displays a custom menu screen for causing a user to select a custom button corresponding to any one of the plurality of functions and makes a transition to an application screen for executing a function corresponding to a custom button selected by the user in accordance with a selection of the custom button via the custom menu screen, and makes a transition to the custom menu screen in response to a completion of an execution of a job related to the function.

### BACKGROUND OF THE INVENTION

Field of the Invention

The present invention relates to an image processing apparatus, a display control method in the same, and a storage medium.

Description of the Related Art

In recent years, image forming apparatuses have a variety of functions, and user operations performed thereon are becoming complex. In general, an image forming apparatus is often shared by a plurality of users, and hence has a mechanism that enables customization of settings in every individual use case. For example, a custom button for which “2-in-1_double-sided” settings are stored (“2-in-1” and “double-sided” are designated as a layout setting and finishing, respectively) can be registered with a menu via a copy application for an image forming apparatus. When a user presses this custom button on a menu screen, a transition is made to a screen of a copy function of the image forming apparatus, and “2-in-1_double-sided” is automatically set. This can save the user the trouble of configuring copy settings (see, for example, Japanese Patent Laid-Open No. 2014-13572).

With the foregoing conventional method, for example, after a transition is made from the menu to the screen of the copy function following the detection of pressing of the custom button for copy, the screen of the copy function is continuously displayed upon completion of copy processing in the image forming apparatus. This may be considered user-unfriendly by, for example, a user who wants to execute processing by sequentially pressing a plurality of custom buttons registered with the menu screen. For example, when a certain user performs task 1 (copy of contracts), task 2 (make electronic copies of receipts and send them), and task 3 (make electronic copies of bills and send them) at the end of work on a daily basis, the user's tasks can be made efficient by registering these tasks 1 to 3 as custom buttons. However, after completion of processing for task 1 that had been performed by pressing the corresponding custom button, in order to press the custom button corresponding to task 2, it is necessary to perform an operation to return to the menu screen with which the custom buttons are registered. The same goes for pressing of the custom button corresponding to task 3 after completion of processing for task 2 that had been performed by pressing the corresponding custom button. As such, the foregoing conventional operation is inefficient for a user who wants to execute processing by sequentially operating a plurality of custom buttons.

### SUMMARY OF THE INVENTION

An aspect of the present invention is to eliminate the above-mentioned problems with conventional technology.

A feature of the present invention is to provide a technique to, after a transition is made to a screen of a function linked to a registered custom button due to pressing of the custom button, automatically return to a set screen.

According to a first aspect of the present invention, there is provided a display control method in an image processing apparatus capable of executing a plurality of functions, the method comprising: a display step of displaying a custom menu screen for causing a user to select a custom button corresponding to any one of the plurality of functions; a first transition step of making a transition to an application screen for executing a function corresponding to a custom button selected by the user in accordance with a selection of the custom button via the custom menu screen; and a second transition step of making a transition to the custom menu screen in response to a completion of an execution of a job related to the function.

According to a second aspect of the present invention, there is provided an image processing apparatus capable of executing a plurality of functions, the apparatus comprising: a display unit configured to display a custom menu screen for causing a user to select a custom button corresponding to any one of the plurality of functions; a first transition unit configured to make a transition to an application screen for executing a function corresponding to a custom button selected by the user in accordance with a selection of the custom button via the custom menu screen; and a second transition unit configured to make a transition to the custom menu screen in response to a completion of an execution of a job related to the function.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows an exemplary hardware configuration of a multi-function peripheral (MFP) serving as an example of an image forming apparatus according to a first embodiment of the present invention.

FIG. 2 is a functional block diagram for describing a software configuration of the MFP according to the first embodiment.

FIG. 3A shows a view illustrating an example of a main menu screen displayed on the MFP according to the first embodiment.

FIG. 3B shows a view illustrating an example of a copy screen.

FIG. 4A shows a view illustrating an example of a custom menu screen displayed on the MFP according to the first embodiment.

FIG. 4B shows a view illustrating an example of a copy screen called from a custom menu.

FIG. 5 shows a view illustrating an example of a copy screen displayed on the MFP according to the first embodiment.

FIG. 6A shows a view illustrating an example of a custom menu screen displayed on the MFP according to the first embodiment.

FIG. 6B shows a view illustrating an example of a custom menu screen displayed upon pressing of an “action setting button for setting actions associated with a job execution.”

FIG. 7 is a block diagram for describing a software configuration of a custom menu control module of the MFP according to the first embodiment.

FIG. 8 shows a view illustrating an exemplary format of setting values used by a custom button control module in the custom menu control module of the MFP according to the first embodiment.

FIG. 9 is a flowchart for describing processing executed by the MFP according to the first embodiment to generate a custom menu screen.

FIG. 10 shows a view illustrating an example of a screen that is displayed in registering a custom button on the MFP according to the first embodiment.

FIGS. 11A and 11B show views illustrating examples of a screen of “register with custom menu: settings at the time of calling” displayed on the MFP according to the first embodiment.

FIG. 12A shows a view illustrating an example of a screen of “register button with custom menu: name and comment” displayed on the MFP according to the first embodiment.

FIG. 12B shows a view illustrating an example of a custom menu screen obtained by registering another custom button with the menu screen shown in FIG. 4A.

FIG. 13 is a flowchart for describing processing executed by the MFP according to the first embodiment to register a custom button.

FIGS. 14A to 16B depict views illustrating an exemplary screen transition caused by pressing of a custom button on the MFP according to the first embodiment.

FIG. 17 is a flowchart for describing processing that is started when the MFP according to the first embodiment has detected pressing of a custom button.

FIG. 18 is a flowchart for describing processing that is started when each function has received a job execution request in the MFP according to the first embodiment.

FIG. 19 is a flowchart for describing the screen transition control processing in step S1807 of FIG. 18.

FIG. 20 is a flowchart for describing processing that is started when the MFP according to the first embodiment has detected some sort of input while a job execution dialogue shown in FIG. 14B, for example, is displayed.

FIG. 21 is a flowchart for describing processing that is executed by the MFP according to the first embodiment when error recovery or a job cancel button is designated by a user operation while an error recovery screen shown in FIG. 15A, for example, is displayed.

FIG. 22 is a flowchart for describing processing that is started upon receiving a predetermined notification from a display-operation control module or an authentication control module in the MFP according to the first embodiment.

FIG. 23 is a flowchart for describing processing that is started when the MFP according to a second embodiment of the present invention has received a job execution request.

FIG. 24 is a flowchart for describing processing that is executed by the MFP according to the second embodiment along with a change in a job state.

FIG. 25 is a flowchart for describing the screen transition control processing in step S1807 of FIG. 18 according to a third embodiment.

FIG. 26 is a flowchart for describing processing that is started when the MFP according to the third embodiment has detected some sort of input while the job execution dialogue 1420 shown in FIG. 14B, for example, is displayed.

FIG. 27 is a flowchart for describing processing that is executed by the MFP according to the third embodiment when error recovery or a job cancel button is designated by a user operation while the error recovery screen shown in FIG. 15A, for example, is displayed.

### DESCRIPTION OF THE EMBODIMENTS

Embodiments of the present invention will be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

In the following description, an image forming apparatus functioning as a multi-function peripheral is used as an example of an information processing apparatus according to the present invention, however, the present invention is not limited to such an image forming apparatus.

### First Embodiment

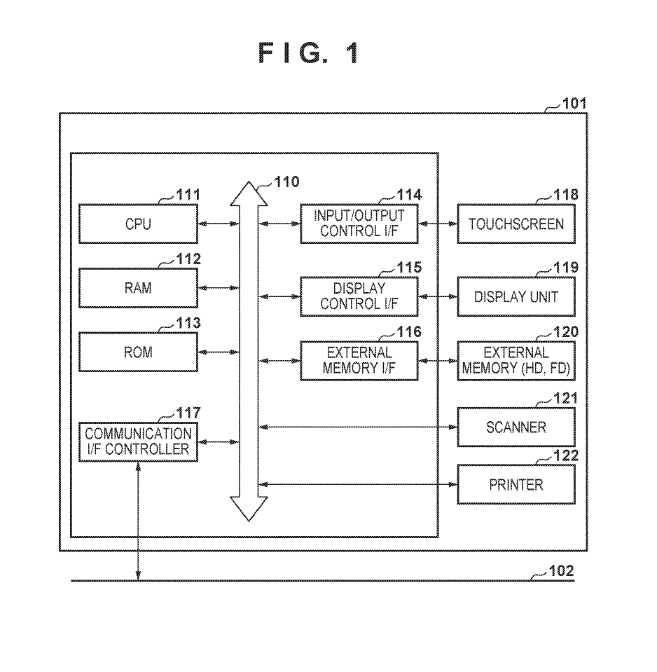

FIG. 1 shows an exemplary hardware configuration of a multi-function peripheral (MFP) 101 serving as an example of an image forming apparatus according to a first embodiment of the present invention. The example of FIG. 1 is presented for the sake of explanation of the present embodiment, and it goes without saying that this hardware configuration may include other constituents or may be replaced with another configuration that achieves the effects similar to the effects achieved by the first embodiment.

A central processing unit (CPU) 111, a random-access memory (RAM) 112, a read-only memory (ROM) 113, an input/output control interface (I/F) 114, a display control I/F 115, an external memory I/F 116, and a communication I/F controller 117 are interconnected via a system bus 110. A scanner 121 and a printer 122 are also connected to the system bus 110. It is via the system bus 110 that the CPU 111 can exchange data and various control/address signals with components connected to the system bus 110. The CPU 111 controls various components and calculates/processes data. The RAM 112 is a volatile memory, and is used as a main memory and a temporary storage area, such as a working area, for the CPU 111. The ROM 113 is a nonvolatile memory in which, for example, image data, other data, and various types of programs necessary for actions of the CPU 111 are stored in their respective predetermined areas. The CPU 111 controls various components of the MFP 101 by, for example, executing a boot program stored in the ROM 113, deploying an OS and programs stored in an external memory 120 to the RAM 112, and executing them. Note that programs necessary for actions of the CPU 111 are not limited to being stored in the external memory 120, and may be stored in the ROM 113.

The input/output control I/F 114 accepts a user operation via a touchscreen 118, generates a control signal corresponding to the user operation, and provides the CPU 111 with the control signal. For example, the input/output control I/F 114 functions as an input device that accepts the user operation, and controls interfaces with a keyboard or a similar text information input device (not shown), a pointing device (not shown), the touchscreen 118, and so on. The touchscreen 118 is, for example, an input device that outputs coordinate information corresponding to a touched position on a planar input unit. Based on the control signal that is generated and provided by the input/output control I/F 114 in accordance with the user operation performed on the input device, the CPU 111 controls various components of the MFP 101 in accordance with programs. This enables the MFP 101 to act in compliance with the user operation.

The display control I/F 115 outputs a display signal for causing a display unit 119 to display an image. For example, the CPU 111 provides the display control I/F 115 with a generated display control signal in accordance with a program. The display control I/F 115 generates the display signal based on the display control signal, and outputs the display signal to the display unit 119. For example, based on the display control signal generated by the CPU 111, the display control I/F 115 causes the display unit 119 to display a graphical user interface (GUI) screen constituting a GUI. The touchscreen 118 and the display unit 119 may be formed integrally. For example, the touchscreen 118 is configured in such a manner that its light transmittance does not obstruct a display performance by the display unit 119, and is mounted over a display surface of the display unit 119. Furthermore, input coordinates on the touchscreen 118 are associated with display coordinates on the display unit 119. In this way, a GUI can be configured that enables a user to directly operate a screen displayed on the display unit 119.

The external memory 120, such as a hard disk drive (HDD), a compact disc (CD), a digital versatile disc (DVD), a flash memory, and a memory card, is attachable to the external memory I/F 116. Under control by the CPU 111, data is read out from the attached external memory 120 and written to the attached external memory 120. In some configurations, the external memory 120 may be used in place of the ROM 113.

Under control by the CPU 111, the communication I/F controller 117 communicates with various networks 102, such as a LAN, the Internet, a wired network, and a wireless network. Various apparatuses, such as a PC, another MFP, a printer, and a server, are connected to the network 102 in such a manner that they can communicate with the MFP 101.

Under control by the CPU 111, the scanner 121 generates image data by reading an original. For example, the CPU 111 causes the scanner 121 to execute scan processing in response to an instruction from a user input via the input/output control I/F 114. The scanner 121 reads an original placed on a platen or an auto document feeder (ADF), and converts an image of the original into digital data, that is to say, image data. The generated image data can be stored to the external memory 120 via the external memory I/F 116. Under control by the CPU 111, the printer 122 prints image data stored in the external memory 120. For example, the CPU 111 causes the printer 122 to execute print processing in response to an instruction from a user input via the input/output control I/F 114, or an instruction of a command input by an external apparatus via the communication I/F controller 117. Furthermore, upon receiving image data stored in the external memory 120, the printer 122 converts the image data into a printable data format, and prints the resultant image data on a sheet.

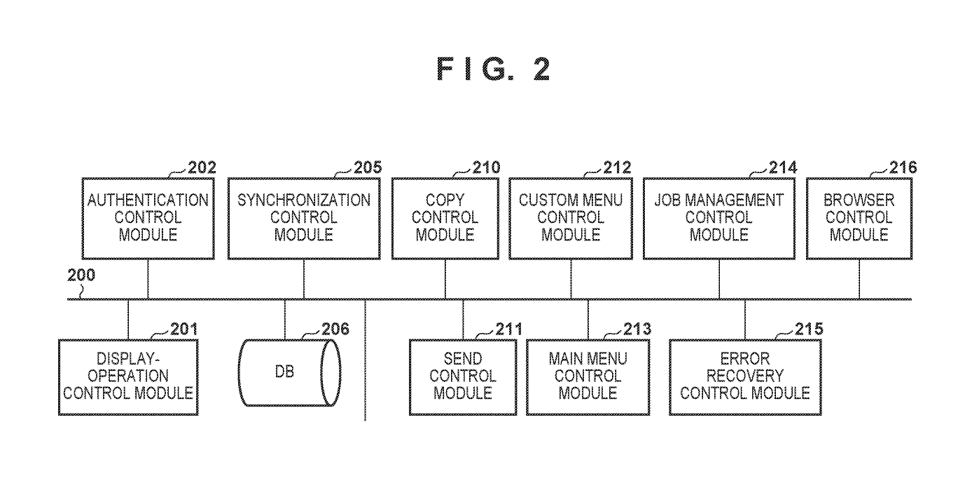

FIG. 2 is a functional block diagram for describing a software configuration of the MFP 101 according to the first embodiment. Note that the example of FIG. 2 is presented for the sake of explanation of the first embodiment, and this software configuration may include other constituents or may be replaced with another configuration that achieves the effects similar to the effects achieved by the first embodiment. Furthermore, programs that realize various control modules shown in FIG. 2 are stored in the ROM 113 or the external memory 120, and various functions are realized by deploying the programs to the RAM 112 and executing the programs under control by the CPU 111 whenever necessary, for example, upon initiation or when using the functions.

A control bus 200 is a virtual bus via which the following components are interconnected to exchange information. The MFP 101 has one or more functions, and control modules are provided in one-to-one correspondence with the functions. Specifically, the following control modules are provided: a display-operation control module 201, an authentication control module 202, a copy control module 210, a send control module 211, a custom menu control module 212, a main menu control module 213, a job management control module 214, an error recovery control module 215, and a browser control module 216. A synchronization control module 205 and a database (DB) 206 are also provided.

It goes without saying that various functions that are other than the functions shown in FIG. 2 and are related to processing of the MFP 101 are provided with their respective control modules (not shown). One example of other functions is a secure print function whereby a print job input by a driver is saved in the MFP 101, and the saved print job can be printed only by an authenticated user or a user who knows a password linked to the print job. Other examples include a box function of storing image data to the MFP 101, a help function of displaying a help screen, and a fax function of receiving a fax document via a public communication network.

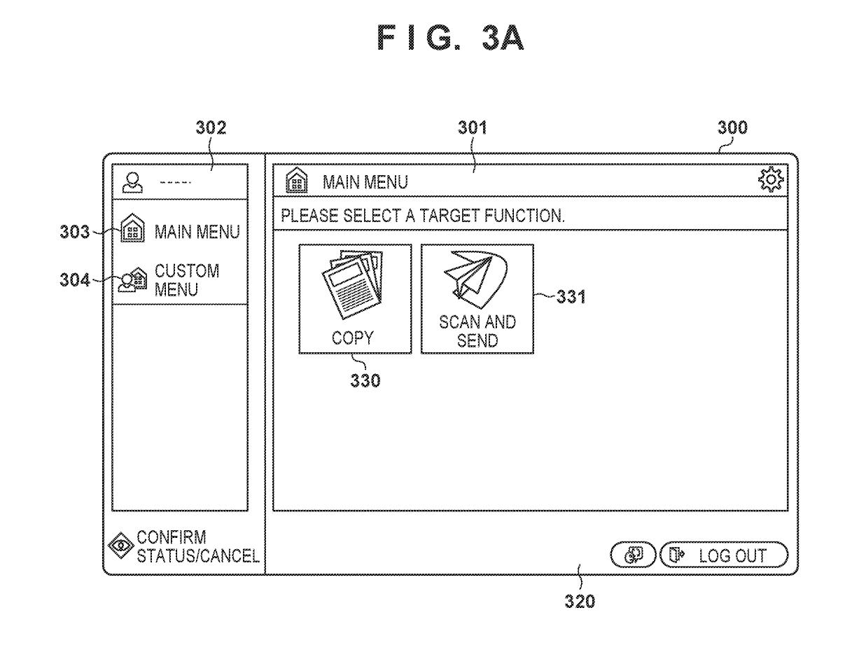

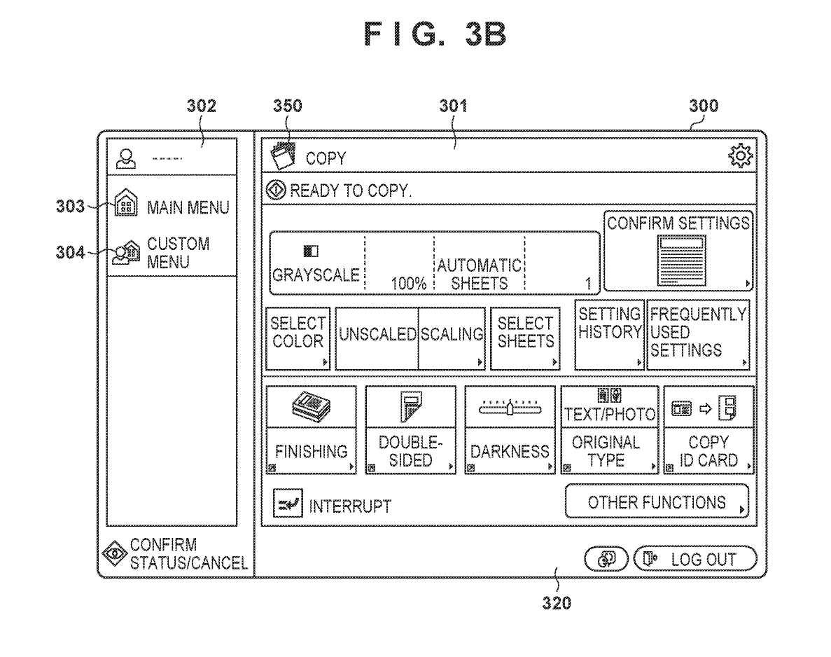

Under control by the CPU 111, the display-operation control module 201 controls the input/output control I/F 114 and the display control I/F 115. For example, the display-operation control module 201 displays an image and the like on the display unit 119 via the display control I/F 115 based on an instruction from another control module, and obtains information that a user has input to the touchscreen 118 via the input/output control I/F 114. The display-operation control module 201 also has a function of displaying screens of various functions on the display unit 119 upon switching to the functions in response to requests from the functions. In the first embodiment, it will be assumed that the states of functions displayed on a main screen area 301 shown in FIGS. 3A and 3B, for example, are “active,” and displaying certain functions on the main screen area 301 is referred to as “activating” the certain functions.

A description is now given of an example of a display performance by the display-operation control module 201 with reference to FIG. 3A.

FIG. 3A shows a view illustrating an example of a main menu screen generated by the main menu control module 213.

Here, the display-operation control module 201 displays a full screen 300, including the main screen area 301, a function selection area 302, and a status area 320, on the display unit 119 via the display control I/F 115. The main screen area 301 displays a screen showing active functions, specifically, a copy button 330 for issuing an instruction for a copy function and a button 331 for issuing an instruction for “scan and send” in FIG. 3A. Buttons 303 and 304 are arranged in the function selection area 302 for the purpose of activating the main menu screen and a custom menu screen that is generated by the custom menu control module 212. The status area 320 displays a job state button, a login button, and a logout button, which will be described later. The status area 320 can be freely used by various functions, and hence its display format is not limited to the one described herein.

Under control by the CPU 111, the authentication control module 202 determines whether an operator of the MFP101 is a legitimate user of the MFP101 by executing authentication (hereinafter, login) processing for user identification. The authentication control module 202 also performs user authentication with reference to a database storing user information in the external memory 120. In the login processing, whether the correspondence between a user name and a password is correct is determined, and if the correspondence is correct, the login processing succeeds and various functions of the MFP 101 become usable within a range of authorities given to a legitimate user. On the other hand, if the login processing fails, control is performed to permit the use of various functions of the MFP 101 within a smaller range of authorities given to an unauthenticated user, or to prohibit the use of all functions. Note that an authentication method is not limited to the one described above, and other authentication methods, such as a method utilizing a contactless IC card, may be used.

The copy control module 210 will now be described. The copy control module 210 controls the copy function of reading an original and printing a copy of the original. The copy control module 210 receives image data input by the scanner 121, applies image processing to the image data, and outputs the image data to the printer 122 that prints the image data. Examples of settings of the copy function include a layout (N-in-1) setting for designating whether to generate one copy image from N originals, and a double-sided setting for designating whether to read one side or both sides of an original. Another example is a color mode setting for designating a color(s) used in printing, such as full color, grayscale, and spot color.

The send control module 211 will now be described. The send control module 211 controls a send function of reading an original and sending the result of reading to an external server. The send control module 211 also generates a file of an ordinary format, such as a Joint Photographic Experts Group (JPEG) format and a TIFF format, by applying image processing to image data input by the scanner 121. Then, for example, it sends the generated file to a server, or sends the generated file as an attachment to an e-mail.

The browser control module 216 will now be described. The browser control module 216 obtains a resource by communicating with a web server via the network 102. Then, it performs syntactic analysis using the CPU 111 based on the type of the obtained resource, arranges the text and images appropriately, and outputs the resultant text and images to the display unit 119 via the display control I/F 115. In one usage example of a browser function, the browser control module 216 issues an HTTP request to a server with a document management function, analyzes a scan request set in a response, and issues a scan request to the scanner 121. Then, it issues a request to register obtained image data with a server as a document.

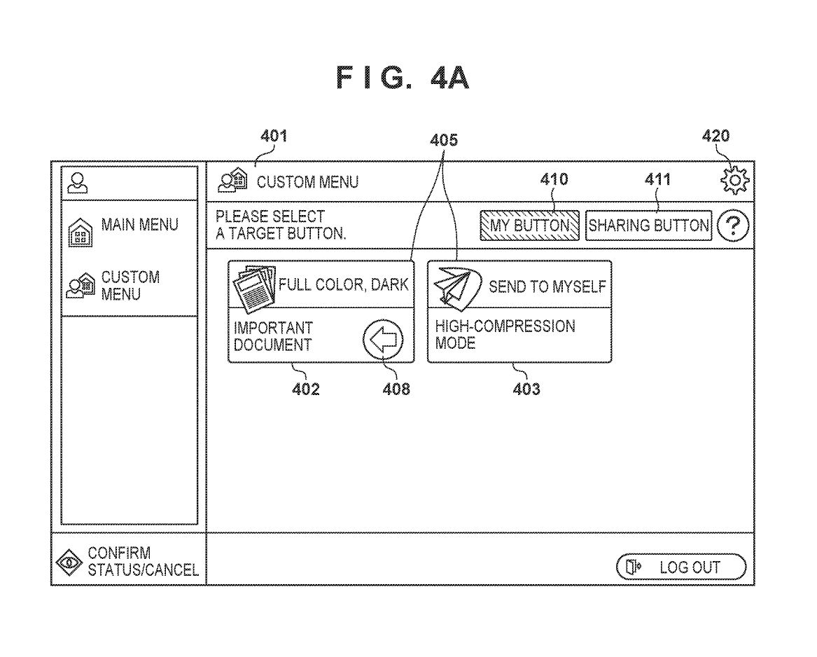

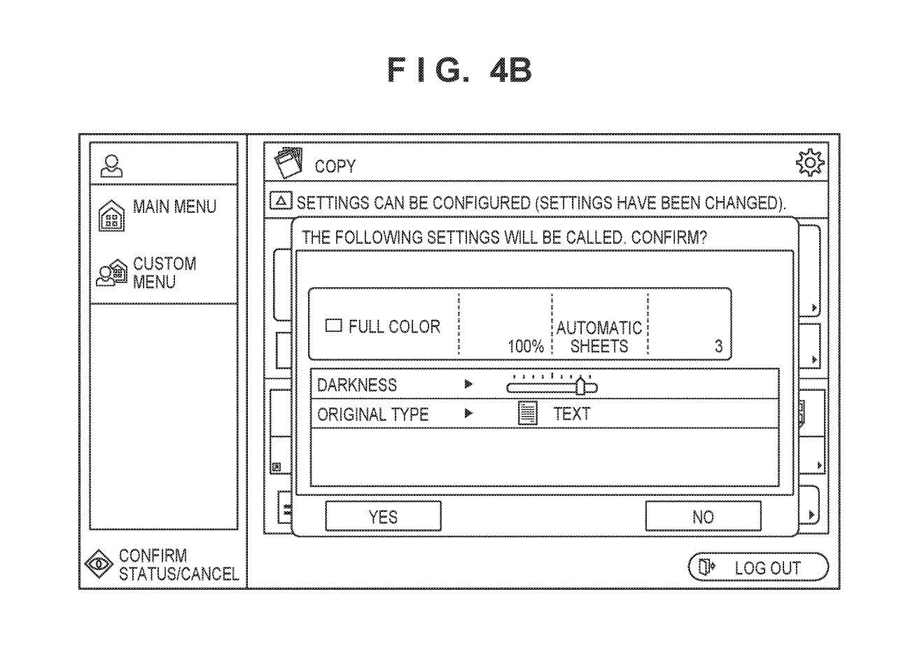

The custom menu control module 212 will now be described. The custom menu control module 212 controls a function of storing settings of other functions and registering them as customizable buttons (hereinafter, custom buttons 405 (FIG. 4A)). The custom menu control module 212 registers shortcut buttons to functions set on a custom menu screen 401 (FIG. 4A) by issuing an instruction for registering custom buttons after settings of other functions have been configured. The details of a custom menu will be described later.

The main menu control module 213 will now be described. The main menu control module 213 controls a function that enables a user to select a desired function and switch to the selected function. Specifically, the main menu control module 213 generates a main menu screen on which an icon corresponding to the copy function is arranged as the copy button 330 as shown in FIG. 3A, for example. When it has detected pressing of the copy button 330, it requests the display-operation control module 201 to activate a screen of the function corresponding to the copy button 330. For instance, based on detection of pressing of the copy button 330 shown in the example of FIG. 3A, a copy screen 350 generated by the copy control module 210 is activated as shown in FIG. 3B, for example.

The job management control module 214 will now be described. The job management control module 214 manages the states of functions of the MFP 101, such as processed printing and scanning, and returns a job state upon receiving a request from a related function. Alternatively, it may have a function of notifying a related function of a change in a job state. The job management control module 214 also stores relationships between jobs and functions to the DB 206 in association with identifiers called job IDs. Examples of the states of a print job include a mid-preparation state where data necessary for image formation is prepared, a mid-execution state where image formation is in operation, a successful termination state where image formation has been completed, and an error state where image formation has failed.

The error recovery control module 215 will now be described. When the error recovery control module 215 has received a notification indicating an error state from the job management control module 214, it generates a screen for recovering from the error state. Then, the error recovery control module 215 requests the display-operation control module 201 to activate itself. When error recovery has been successfully accomplished through a predetermined user operation, the error recovery control module 215 requests the display-operation control module 201 to activate a function that issued a related job. Note that with regard to a job that has been issued upon detection of pressing of a custom button 405 by the custom menu control module 212, a screen transition is controlled in accordance with screen transition settings in the custom menu control module 212. Furthermore, when a user has requested cancellation of a job that is currently in an error state, the display-operation control module 201 is requested to activate a function that issued the job or the custom menu control module 212, similarly to the case of error recovery. The details of actions related to a screen transition involving the error recovery control module 215 will be described later.

The browser control module 216 will now be described. The browser control module 216 obtains a resource by communicating with a web server via the network 102. Then, it performs syntactic analysis using the CPU 111 based on the type of the obtained resource, and outputs/displays a screen on which the text and images are appropriately arranged to/on the display unit 119 via the display control I/F 115. In one usage example of a browser function, the browser control module 216 issues an HTTP request to a server with a document management function, analyzes a scan request set in a response to the HTTP request, and issues a scan request to the scanner 121. Then, it registers image data obtained by the scanner 121 with a server as document data.

The DB 206 is a storage area that is used by various functions, specific to the MFP 101, and provided in the RAM 112 or the external memory 120.

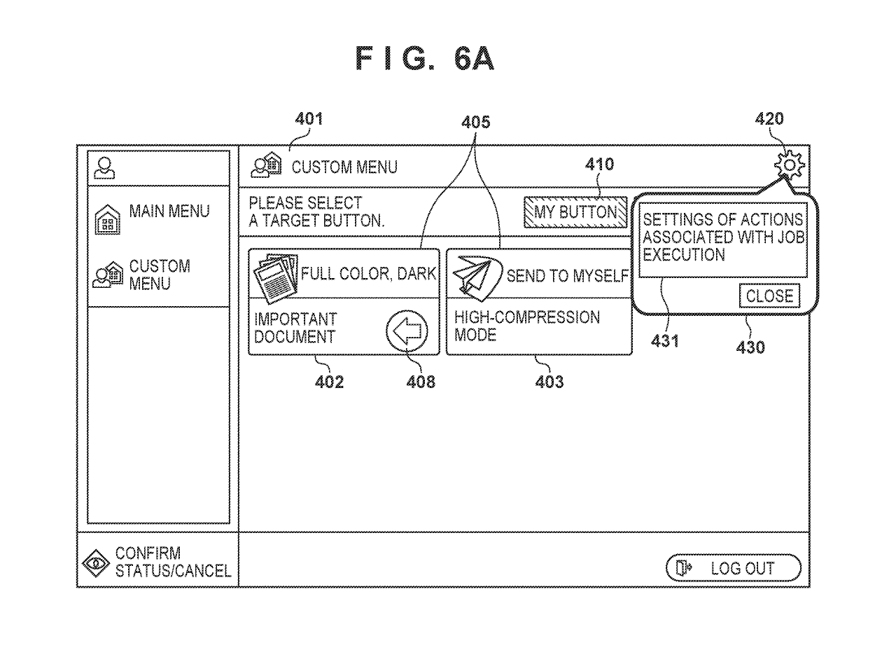

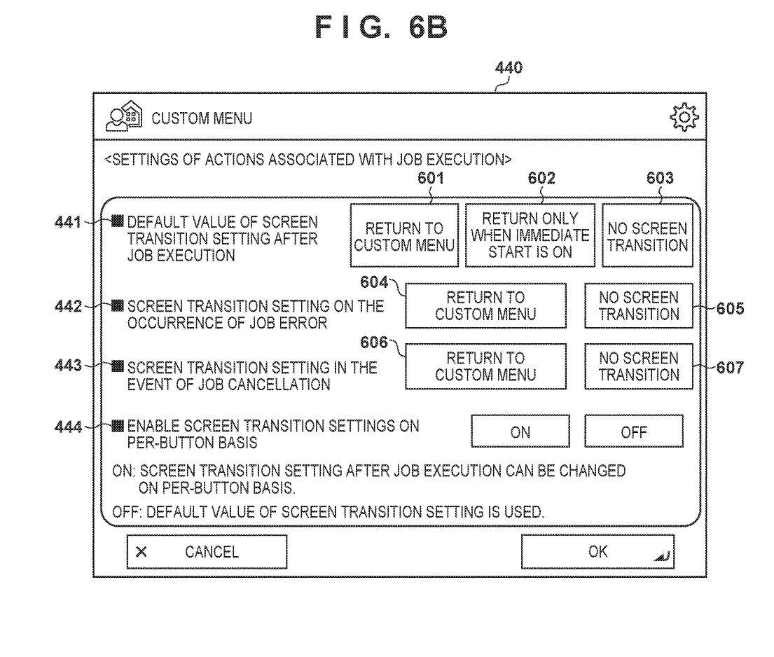

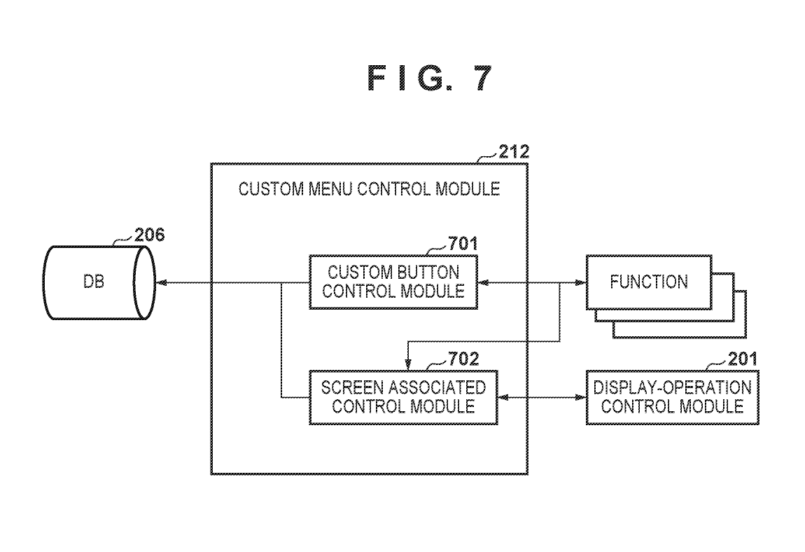

FIGS. 4A to 6B are diagrams for describing a custom menu screen displayed on the MFP 101 according to the first embodiment. The following describes a basic structure of a screen displayed by the aforementioned custom menu control module 212, and functions of various UI components. Note that the function selection area 302 is omitted in FIG. 6B and the subsequent figures as it need not be focused therein.

FIG. 4A shows a view illustrating an example of the custom menu screen 401, which is generated by a screen associated control module 702 shown in FIG. 7 and displays two custom buttons 402 and 403. When the custom button 402 is pressed, the copy control module 210 is initiated, and a transition is made to the copy function. When the custom button 403 is pressed, the send control module 211 is initiated, and a transition is made to send processing. In the first embodiment, a custom button(s) 405 is used as a collective term for custom buttons, and custom buttons 402 and 403 are used in referring to individual custom buttons. Furthermore, a return icon 408 appended to the custom button 405 indicates that the execution of job linked to the custom button 405 is automatically followed by a return to the custom menu screen 401 shown in FIG. 4A. Specifically, copy processing is started by pressing the custom button 402, and termination of the copy processing is automatically followed by a return to the custom menu screen 401. On the other hand, the send processing is started upon pressing of the custom button 403, and termination of the send processing is not automatically followed by a return to the custom menu screen 401.

The purpose of a my button 410 is to display dedicated buttons that are linked to a login user accepted by the authentication control module 202 and that are managed on a per-user basis. In contrast, the purpose of a sharing button 411 is to display buttons that can be commonly used by unauthenticated users who have not completed login performed by the authentication control module 202, or all users. If the authentication control module 202 has a mechanism to manage a plurality of users on a per-group basis, a group button for displaying usable buttons on a per-group basis may be added.

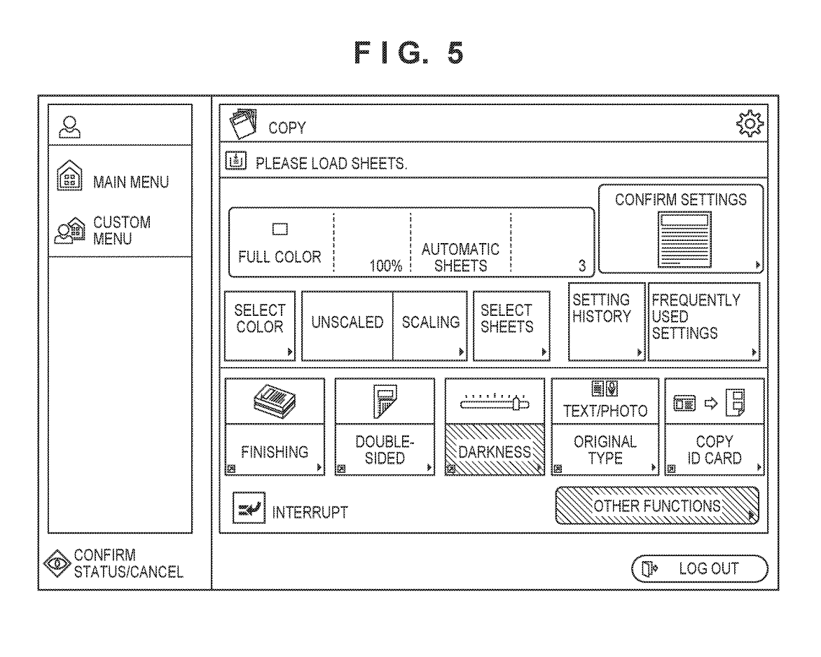

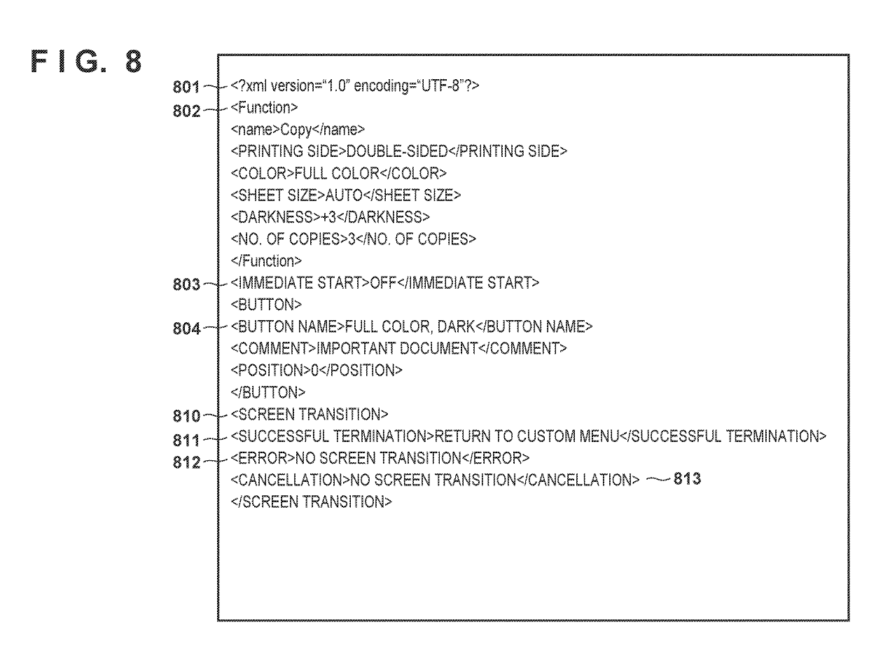

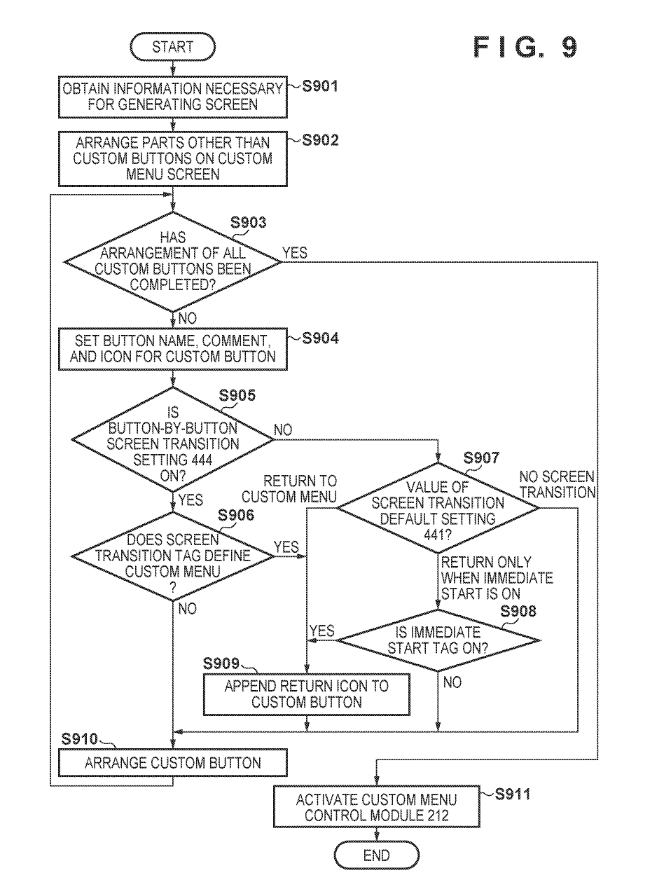

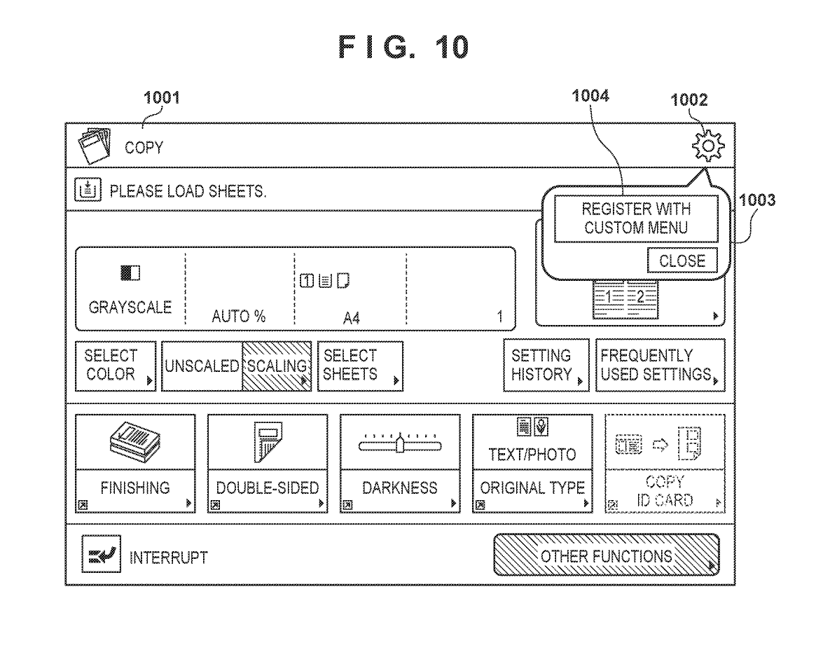

When the custom menu control module 212 has detected pressing of the custom button 402 or 403 via the input/output control I/F 114, it issues a request for setting information obtained from the DB 206 and a call request to a corresponding control module. For example, when the custom menu control module 212 has detected pressing of the custom button 402, it issues a call request to the copy control module 210. In response, the copy control module 210 causes the display unit 119 to display a confirmation dialogue shown in FIG. 4B, for example. FIG. 4B shows that the following setting values have been provided to the copy control module 210 via a custom button control module 701 (FIG. 7): full color, a darkness level is three times higher than a standard level, and the original type is text. Note that these setting values are provided to the copy control module 210 via the custom button control module 701 in an XML format shown in FIG. 8, for example. The details will be described later. When the copy control module 210 has detected pressing of a “yes” button shown in FIG. 4B, it displays a copy screen shown in FIG. 5, for example, reflecting the aforementioned setting values on the display unit 119 via the display control I/F 115. Thereafter, a copy job is executed in a state where the setting values provided by the custom menu control module 212 have been reflected, and completion of the execution of the copy job is followed by a return to the custom menu screen 401 shown in FIG. 4A.

When the screen associated control module 702 shown in FIG. 7 has detected pressing of a custom menu setting button 420 shown in FIG. 4A, it displays a balloon menu 430 (FIG. 6A) for changing various settings in the custom menu control module 212. An action setting button 431 for setting actions associated with a job execution is arranged in this balloon menu 430. When the screen associated control module 702 has detected pressing of this button 431, it generates and displays a custom menu screen 440 shown in FIG. 6B, for example, for setting actions associated with a job execution. Buttons for selecting a background image of the custom menu screen 401, changing the sizes of the custom buttons 405, restricting the functions of the custom buttons 405 may be included in the balloon menu 430.

The custom menu screen 440 shown in FIG. 6B includes a screen transition default setting 441 for setting a default value of a screen transition setting after a job execution. The screen transition default setting 441 is provided with a button 601 for setting a return to the custom menu screen 401, and a button 602 for setting a return to the custom menu screen 401 only when an immediate start associated with a custom button 405 is ON. It is also provided with a button 603 for configuring a setting in which a job execution is not followed by a return to the custom menu. Note that an immediate start means the execution of a job corresponding to a custom button 405 immediately after a desired function is activated by pressing the custom button 405. The custom menu screen 440 further includes a screen transition setting 442 on the occurrence of job error, and this setting is provided with a button 604 for setting a return to the custom menu screen 401 and a button 605 for making no screen transition on the occurrence of an error during a job execution. A screen transition setting 443 in the event of job cancellation is provided with a button 606 for setting a return to the custom menu screen 401 and a button 607 for making no screen transition in the event of job cancellation. A button-by-button screen transition setting 444 is provided with an ON button and an OFF button for designating whether to enable a screen transition setting on a per-button basis. When the button-by-button screen transition setting 444 is ON, if information of a custom button 405 defines a screen transition, the defined screen transition is prioritized over the screen transition default setting 441 after a job execution. Conversely, when the button-by-button screen transition setting 444 is OFF, a setting value of the screen transition default setting 441 after a job execution is prioritized even if information of a custom button 405 defines a screen transition.

Note that the screen transition default setting 441 after a job execution, the screen transition setting 442 on the occurrence of job error, the screen transition setting 443 in the event of job cancellation, and the button-by-button screen transition setting 444 may be managed as common setting values throughout the entire system. Alternatively, these settings may be provided on a per-user basis. In other words, when the authentication control module 202 has executed the login processing successfully, these settings may be managed as setting values specific to a user who has logged in, and user settings may be prioritized over setting values in the entire system.

FIG. 7 is a block diagram for describing a software configuration of the custom menu control module 212 of the MFP 101 according to the first embodiment.

The custom menu control module 212 includes a custom button control module 701 and the screen associated control module 702. In response to a request for registration of a custom button from a function, the custom button control module 701 sets information related to the button in the DB 206. It also reads in information related to a custom button 405 from the DB 206 and calls a corresponding function when the custom button 405 is pressed. The screen associated control module 702 generates a screen that includes custom buttons and that is output by the custom menu control module 212 to the display unit 119. For instance, it generates the custom menu screen 401 shown in FIG. 4A, for example, on which custom buttons 405 are arranged with appropriate icons appended thereto. It also generates auxiliary screens, such as the balloon menu 430 shown in FIG. 6A and the custom menu screen 440 shown in FIG. 6B, for example. The details of generation of the custom menu screen 401 will be described later. The screen associated control module 702 also stores various setting values set on the custom menu screen 440 shown in FIG. 6B, for example, to the DB 206. Furthermore, when the screen associated control module 702 accepts a request for a screen transition to the custom menu screen 401 from each function, it generates the custom menu screen 401 and requests the display-operation control module 201 to activate the custom menu control module 212.

FIG. 8 shows an exemplary format of setting values used by the custom button control module 701 in the custom menu control module 212 of the MFP 101 according to the first embodiment. Although custom button setting values 801 are described in an XML format in the first embodiment, they may be described in any format that can handle setting values.

A function tag 802 specifies a function corresponding to a custom button 405, in the present example, it indicates the copy control module 210. The function tag 802 defines various settings of the corresponding function, in the present example, it indicates double-sided printing, full color, automatic detection of a sheet size, a darkness of +3 compared to a standard value, and 3 as the number of copies to be printed. An immediate start tag 803 indicates a setting of whether to reflect setting values of the custom button 405 in the corresponding function and immediately execute a job upon pressing of the custom button 405 without detection of pressing of a start key (not shown) on the touchscreen 118. When the immediate start tag 803 is set to “ON,” the job of the custom button 405 is immediately executed. In FIG. 8, it is set to “OFF,” that is to say, upon pressing of the custom button 405, the setting values are reflected in the corresponding function, and no further progress is made.

A button tag 804 defines a button name, a comment, and a button position of the custom button 405 output to the custom menu screen 401 shown in FIG. 6A. The button position is information indicating the order in which this button is arranged on the custom menu screen 401. In FIG. 8, “0” is designated as the button position, which corresponds to the position of the custom button 402 on the custom menu screen 401 shown in FIG. 6A. The larger the number indicating the position, the more rightward and downward the custom button 405 is arranged on the custom menu screen 401.

A screen transition tag 810 defines a function serving as a transition destination when the execution of the custom button 405 has been successfully terminated, when an error has occurred during the execution, or when the execution has been cancelled. These events correspond to a successful termination tag 811, an error tag 812, and a cancellation tag 813. In the settings of the present example, successful termination of the job is followed by a return to the custom menu screen 401, and no screen transition is performed on the occurrence of an error or in the event of cancellation. The details of screen transition processing will be described later.

Note that any one of various jobs, including a copy job, a print job, and a send job, is associated with the setting values defined in the above-described manner, and values of all tags, such as the function tag 802 and the immediate start tag 803, are set at the time of job generation. Therefore, all of the custom button setting values 801 are included among setting values of any job. That is to say, tags defined by the custom button setting values 801 can be referenced from setting values of jobs, and thus they will be handled collectively without using distinct names in the following description.

FIG. 9 is a flowchart for describing processing executed by the MFP 101 according to the first embodiment to generate the custom menu screen 401. This processing is achieved by the CPU 111 functioning as the screen associated control module 702 shown in FIG. 7. As this processing is realized by the CPU 111 executing a program deployed from the ROM 113 or the external memory 120 to the RAM 112, it will be described herein as processing executed by the CPU 111.

This processing is started upon input of a request to display the custom menu screen 401, and the CPU 111 first obtains information necessary for generating the custom menu screen 401 shown in FIG. 4A, for example, from the DB 206 in step S901. Examples of the necessary information include the positions and sizes of buttons, icons, button names, and comments. Next, the processing proceeds to step S902 and the CPU 111 arranges parts that constitute the custom menu screen 401 and are other than custom buttons 405 (e.g., the my button 410, the sharing button 411, the custom menu setting button 420, and various sentences).

Next, the processing proceeds to step S903 and the CPU 111 determines whether or not the generation and arrangement of all custom buttons 405 have been completed; it proceeds to step S911 if the generation and arrangement have been completed, and to step S904 if the generation and arrangement have not been completed. In step S904, the CPU 111 prepares a custom button 405 with a button name, a comment, and an icon set therefor. Next, the processing proceeds to step S905 and the CPU 111 determines whether or not the button-by-button screen transition setting 444, which has been described with reference to FIG. 6B, is “ON;” it proceeds to step S906 in the case of “ON,” and to step S907 in the case of “OFF.” In step S906, the CPU 111 determines whether or not the screen transition tag 810 defines “return to custom menu.” If the CPU 111 determines that “return to custom menu” is not defined, the processing proceeds to step S910. In step S910, the CPU 111 arranges the custom button 405, which is ready to be formed, on the custom menu screen 401 based on its button position, and the processing proceeds to step S903.

On the other hand, if the CPU 111 determines in step S906 that the screen transition tag 810 defines the custom menu, the processing proceeds to step S909, and the CPU 111 appends the return icon 408 (FIG. 4A) to the custom button 405, and the processing proceeds to step S910. This makes it evident that completion of processing associated with this custom button is automatically followed by a return to the custom menu screen 401.

If the CPU 111 determines in step S905 that the button-by-button screen transition setting 444 is “OFF,” the processing proceeds to step S907 and the CPU 111 confirms a value of the screen transition default setting 441. If the CPU 111 determines that “return to custom menu” 610 is set in step S907, the processing proceeds to step S909, and the CPU 111 appends the return icon 408 to the custom button 405, and the processing proceeds to step S910. This also makes it evident that completion of processing associated with this custom button is automatically followed by a return to the custom menu screen 401.

If the CPU 111 determines in step S907 that “return only when immediate start is ON” 602 is set, the processing proceeds to step S908 and the CPU 111 confirms a value of the immediate start tag 803. If the immediate start tag 803 is “ON,” the processing proceeds to step S909, and the CPU 111 appends the return icon 408 to the custom button 405, and the processing proceeds to step S910; if the immediate start tag 803 is “OFF,” the processing proceeds to step S910. If the value of the screen transition default setting 441 is “no screen transition” 603 in step S907, the processing proceeds to step S910. When the arrangement and generation of all custom buttons 405 have been completed, the processing proceeds from step S903 to step S911 and the CPU 111 requests the display-operation control module 201 to activate the custom menu control module 212. Then, the custom menu screen 401 is displayed.

Note that the positions of parts on the screen may be prepared as a template file in, for example, an XML format or an HTML format, and the style of the screen may be changed in accordance with the template file. In other words, as long as the information necessary for generating the screen has been obtained, a method of generating the screen in the final stage is not limited to the one described above in the first embodiment.

With the foregoing processing, when the execution of a job caused by pressing of a custom button is automatically followed by a return to the menu screen, the custom button is displayed with the return icon 408 appended thereto.

FIGS. 10 to 12B show views illustrating examples of screens that are displayed in registering a custom button 405 on the MFP 101 according to the first embodiment.

Here, the CPU 111 functions as the copy control module 210 and displays a copy screen 1001 on the display unit 119. Upon detection of pressing of a copy setting button 1002 on the copy screen 1001, a balloon menu 1003 is generated and displayed on the copy screen 1001 as shown in FIG. 10, for example. At this time, the balloon menu 1003 displays a “register with custom menu” button 1004.

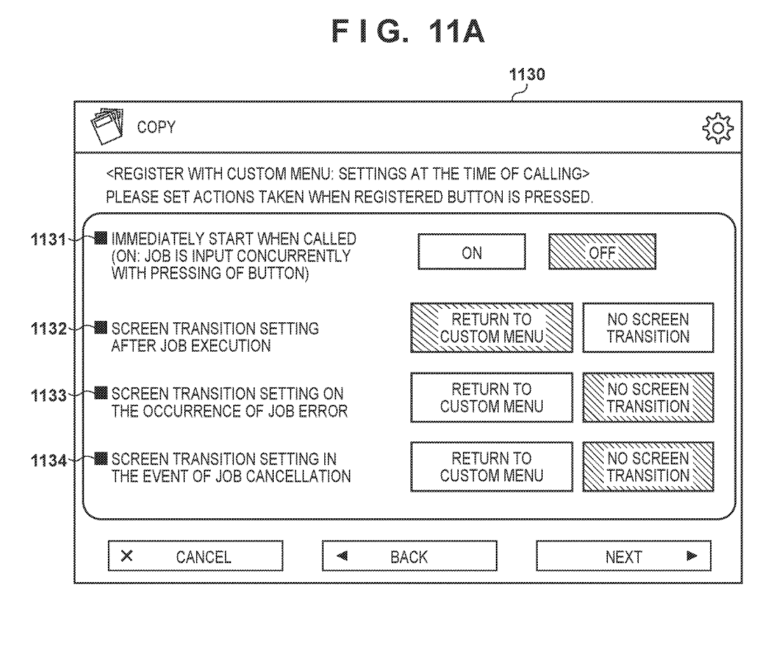

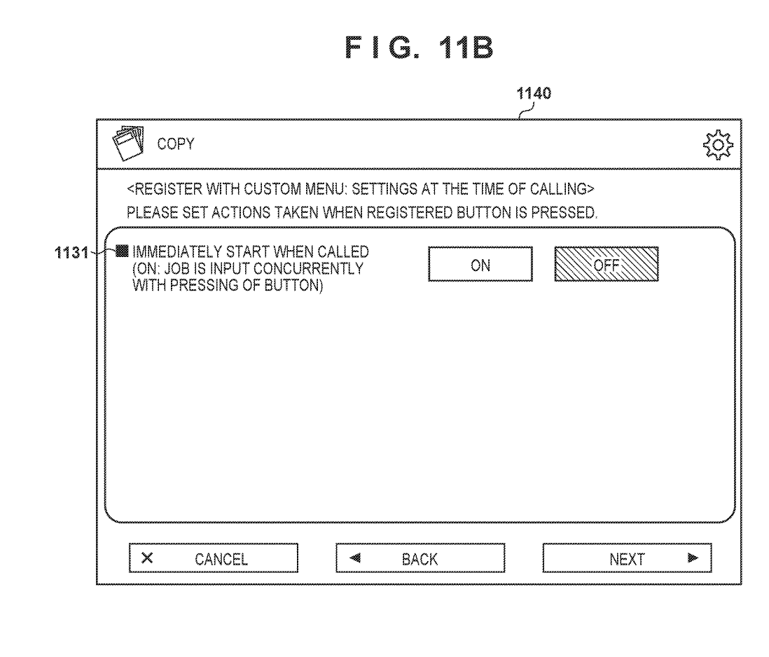

When the CPU 111 has detected pressing of the “register with custom menu” button 1004, it requests the custom menu control module 212 for a screen of “register with custom menu: settings at the time of calling” shown in FIG. 11A or 11B, for example. At this time, when the button-by-button screen transition setting 444 shown in FIG. 6B is “ON,” a screen 1130 of “register with custom menu: settings at the time of calling” shown in FIG. 11A, for example, is displayed. On the other hand, when the button-by-button screen transition setting 444 shown in FIG. 6B is “OFF,” a screen 1140 of “register with custom menu: settings at the time of calling” shown in FIG. 11B, for example, is displayed. Note that the settings displayed on these screens 1130 and 1140 are configured via the aforementioned screen 440 shown in FIG. 6B, for example. The screen shown in FIG. 11A differs from the screen shown in FIG. 11B in including a screen transition setting 1132 after a job execution, a screen transition setting 1133 on the occurrence of job error, and a screen transition setting 1134 in the event of job cancellation. The details of initial values of these setting values will be described later.

The screens 1130 and 1140 of “register with custom menu: settings at the time of calling” both include a setting item 1131 corresponding to “immediately start when called,” which is linked to the immediate start tag 803 shown in FIG. 8. The settings on the screen 1130 of “register with custom menu: settings at the time of calling” are as follows. The setting item 1131 corresponding to the immediate start is OFF, the screen transition setting 1132 after a job execution is “return to custom menu,” and the screen transition setting 1133 on the occurrence of job error and the screen transition setting 1134 in the event of job cancellation are both “no screen transition.” On the other hand, on the screen 1140 of “register with custom menu: settings at the time of calling” shown in FIG. 11B, the setting item 1131 corresponding to the immediate start is OFF.

The custom menu control module 212 makes a transition to the next screen upon detection of pressing of a next button, which is located at the bottom right of the screen, after completion of the settings on the screens 1130 or 1140 of “register with custom menu: settings at the time of calling.” In the following description, it will be assumed that the transition is made from the screen 1130 of “register with custom menu: settings at the time of calling” to the next screen by way of example.

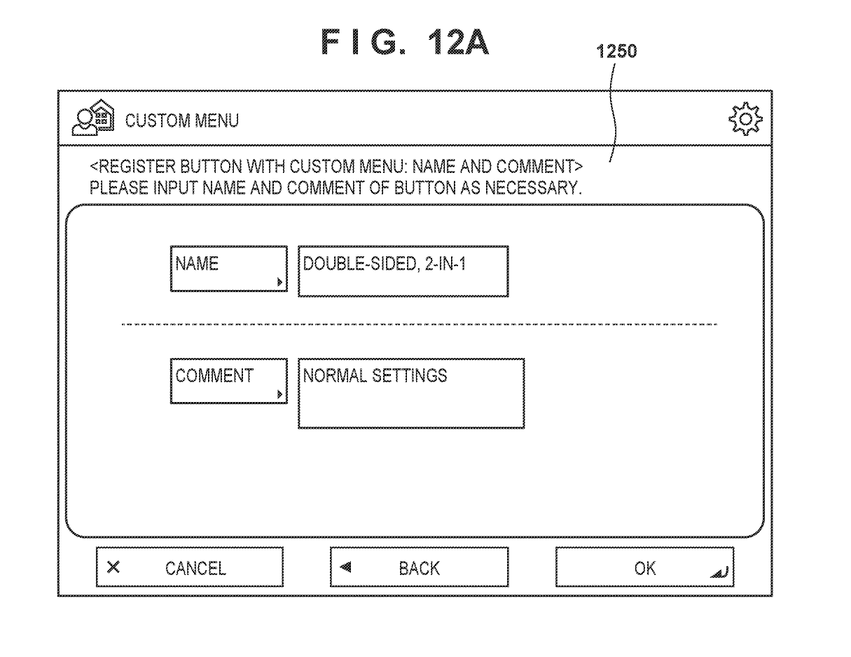

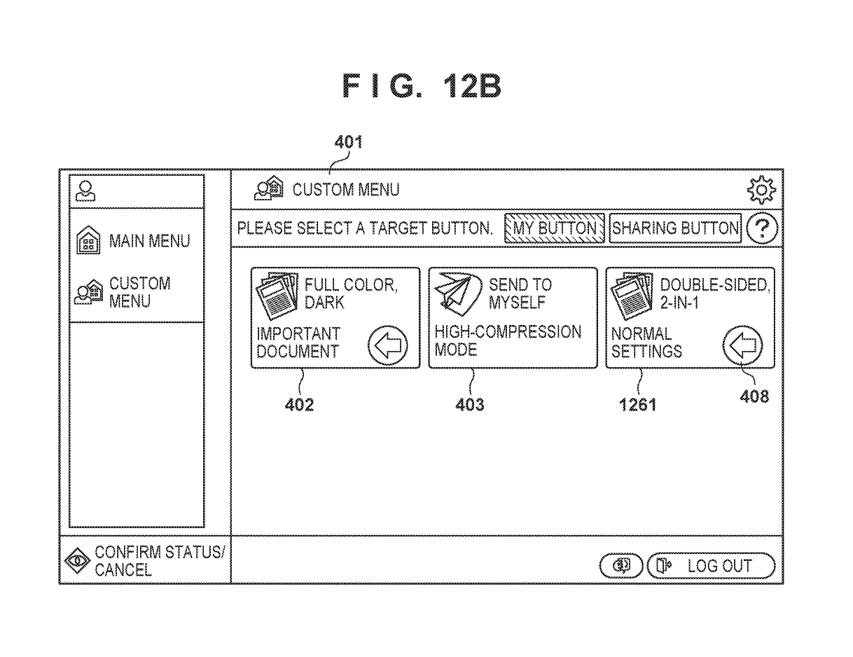

The next screen is a screen 1250 of “register button with custom menu: name and comment” shown in FIG. 12A, for example, and the name and comment of a button can be input via this screen. FIG. 12A shows a state where “double-sided, 2-in-1” has been input as the name, and “normal settings” has been input as the comment. When the custom menu control module 212 has detected pressing of an OK button located at the bottom right of this screen, it registers a corresponding custom button 405 with the DB 206. In this state, as shown in FIG. 12B, for example, the custom menu screen 401 displays a custom button 1261 that has been newly registered through the foregoing procedure, in addition to parts on the custom menu screen shown in FIG. 4A.

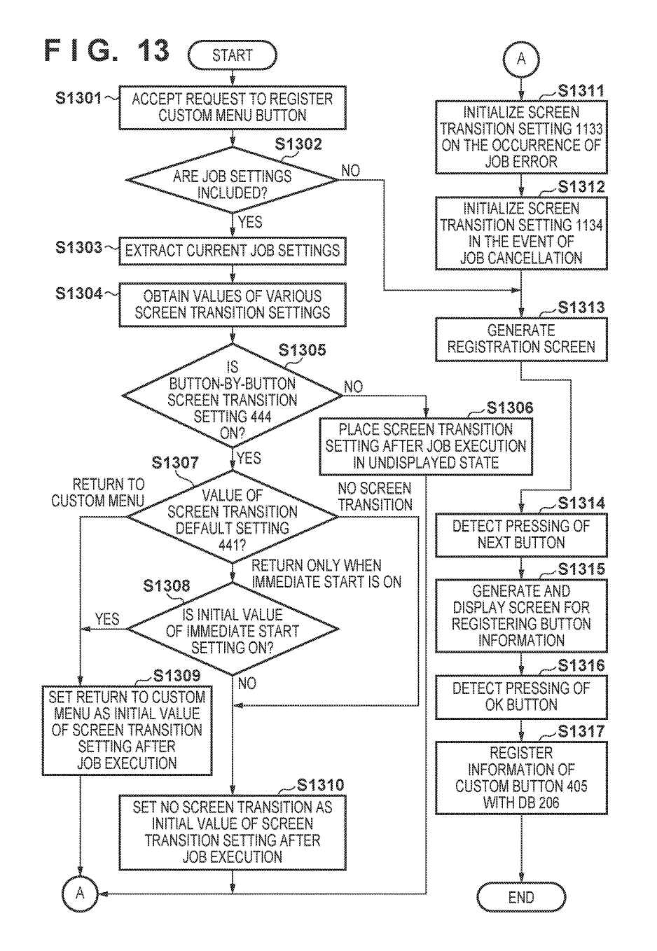

FIG. 13 is a flowchart for describing processing executed by the MFP 101 according to the first embodiment to register a custom button 405. This processing is achieved by the CPU 111 functioning as the custom menu control module 212. As this processing is realized by the CPU 111 executing a program deployed from the ROM 113 or the external memory 120 to the RAM 112, it will be described herein as processing executed by the CPU 111.

First, in step S1301, the CPU 111 accepts a request to register a custom menu button from a function. Next, the processing proceeds to step S1302 and the CPU 111 determines whether or not job settings are included in the request. The processing proceeds to step S1313 if it determines that the job settings are not included, and to step S1303 if it determines that the job settings are included. Note that some functions, such as the browser control module 216, are not linked to jobs. When the CPU 111 has detected pressing of a registered custom button 405 on a web browser, it activates the browser control module 216. In the case of a screen transition with the purpose of simply displaying a web page, the browser control module 216 does not execute any job. Therefore, in registration of a custom button 405 with the purpose of simply making a transition to a web page without involving job settings, screen transition settings are unnecessary. However, it is possible to request a job execution via the network 102 along with POST or GET processing executed by the browser control module 216. In this case, it is determined that the job settings are included in the request for button registration, and the processing proceeds to step S1303.

In step S1303, the CPU 111 stores values of the job settings provided by the function to the RAM 112. Next, the processing proceeds to step S1304 and the CPU 111 obtains the screen transition default setting 441, the screen transition setting 442 on the occurrence of job error, the screen transition setting 443 in the event of job cancellation, and the button-by-button screen transition setting 444 from the DB 206. Then, the processing proceeds to step S1305 and the CPU 111 determines whether or not the button-by-button screen transition setting 444 is ON. If the CPU 111 determines that the screen transition setting 444 is OFF, the processing proceeds to step S1306 and the CPU 111 prepares the screen 1140 of “register with custom menu: settings at the time of calling” (FIG. 11B) as a screen to be displayed.

On the other hand, if it determines in step S1305 that the button-by-button screen transition setting 444 is ON, the processing proceeds to step S1307. In step S1307, the CPU 111 confirms a value of the screen transition default setting 441 after a job execution. If the screen transition default setting 441 is “return to custom menu,” the processing proceeds to step S1309, and the CPU 111 sets the screen transition setting 1132 after a job execution shown in FIG. 11A to “return to custom menu,” and the processing proceeds to step S1311. If the screen transition default setting 441 is “no screen transition” in step S1307, the processing proceeds to step S1310, and the CPU 111 sets the screen transition setting 1132 after a job execution to “no screen transition,” and the processing proceeds to step S1311. If the screen transition default setting 441 is “return only when immediate start is ON” in step S1307, the processing proceeds to step S1308 and the CPU 111 determines whether or not an initial value of the immediate start setting is ON. The processing proceeds to step S1309 if it is determined that the initial value is ON, and to step S1310 if it is determined that the initial value is OFF. Note that the initial value of the immediate start setting may be stored in the DB 206 as a fixed value, may be selectable on the custom menu screen 440 shown in FIG. 6B, or may be settable on another setting screen.

In step S1311, the CPU 111 sets a value of the screen transition setting 442 on the occurrence of job error shown in FIG. 6B as an initial value of the screen transition setting 1133 on the occurrence of job error. Next, the processing proceeds to step S1312 and the CPU 111 sets a value of the screen transition setting 443 in the event of job cancellation shown in FIG. 6B as an initial value of the screen transition setting 1134 in the event of job cancellation. Then, the processing proceeds to step S1313, and the CPU 111 generates and displays the screen 1130 of “register with custom menu: settings at the time of calling” (FIG. 11A). Next, the processing proceeds to step S1314, and when the CPU 111 detects pressing of the next button located at the bottom right of this screen, the processing proceeds to step S1315, and the CPU 111 generates the screen 1250 of “register button with custom menu: name and comment” shown in FIG. 12A, and displays the same on the display unit 119. Next, the processing proceeds to step S1316, and when the CPU 111 detects pressing of the OK button on this screen 1250, the processing proceeds to step S1317 and the CPU 111 obtains, from the RAM 112, the values of the job settings stored in step S1303 as information related to a new custom button 405. The obtained values and various screen transition settings are formatted as shown in FIG. 8, and registered with the DB 206. This concludes the description of the processing for registering a custom button 405.

Note that values set to the screen transition setting 1132 after a job execution, the screen transition setting 1133 on the occurrence of job error, and the screen transition setting 1134 in the event of job cancellation are reflected in the successful termination tag 811, the error tag 812, and the cancellation tag 813 shown in FIG. 8.

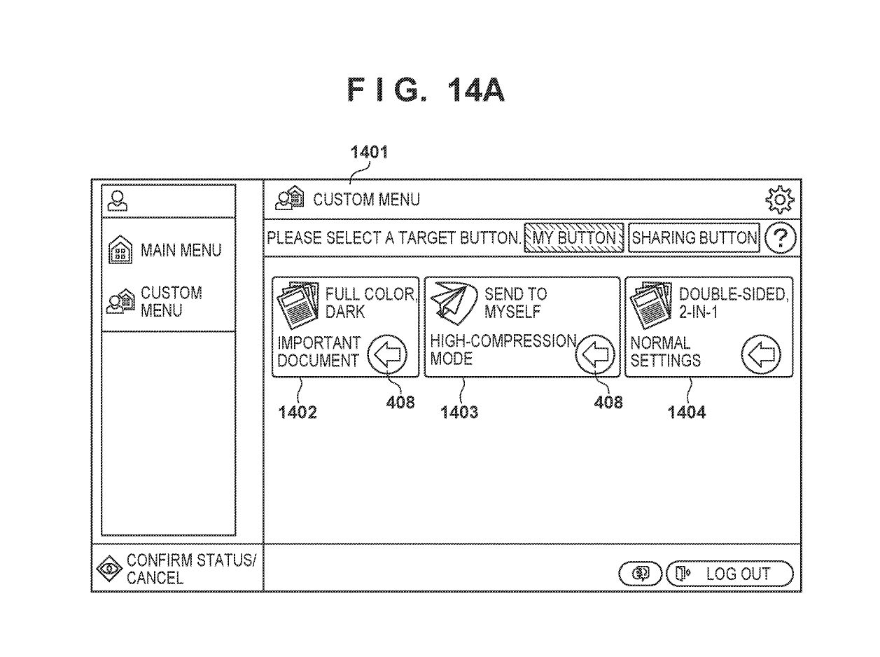

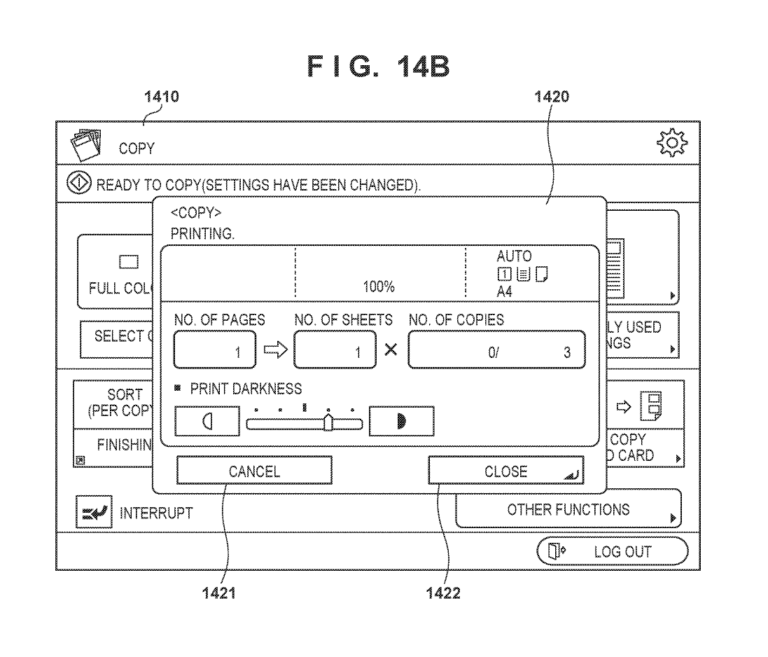

FIGS. 14A to 16B are drawings for describing an exemplary screen transition caused by pressing of a custom button 405 on the MFP 101 according to the first embodiment.

Three custom buttons 1402 to 1404 are arranged on a custom menu screen 1401 shown in FIG. 14A. When the custom menu control module 212 has detected pressing of the custom button 1402 on the custom menu screen 1401, it provides the copy control module 210 with corresponding setting values. Once the copy control module 210 has completed generation of a copy screen 1410 shown in FIG. 14B, for example, the custom menu control module 212 requests the display-operation control module 201 to activate the copy control module 210, and displays the copy screen 1410. Thereafter, once a copy job has been started, the copy control module 210 displays a job execution dialogue 1420 on the copy screen 1410. When the copy job has been successfully terminated, the custom menu control module 212 requests the display-operation control module 201 to activate itself as the return icon 408 is appended to the custom button 1402. Then, the custom menu screen 1401 shown in FIG. 14A is displayed.

When pressing of a cancel button 1421 on the job execution dialogue 1420 shown in FIG. 14B has been detected, the copy job is cancelled and terminated. In this case, a transition is made to one of the custom menu screen 1401 and the copy screen 1410. Here, one of these screens is decided on as a transition destination based on the settings configured on the custom menu screen 440 shown in FIG. 6B or the settings configured on the screen 1130 of “register with custom menu: settings at the time of calling” shown in FIG. 11A. The details of a method of deciding on a screen serving as a transition destination will be described later.

When pressing of a close button 1422 on the job execution dialogue 1420 has been detected by a function on the screen shown in FIG. 14B, it is determined that the copy job has been successfully terminated, and the display-operation control module 201 is requested to activate the custom menu control module 212. As a result, a transition is made to the custom menu screen 1401 shown in FIG. 14A, that is to say, this menu screen is displayed.

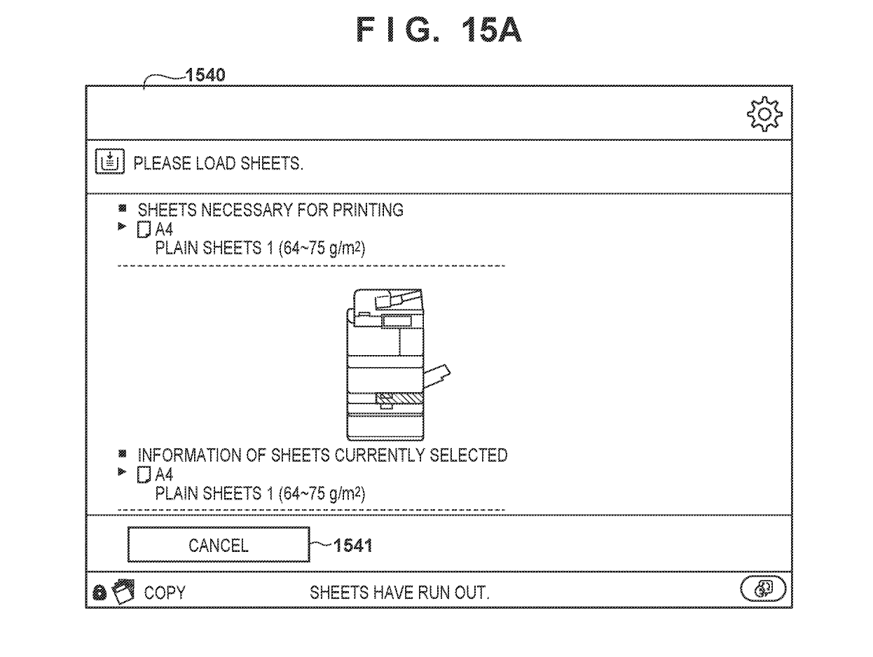

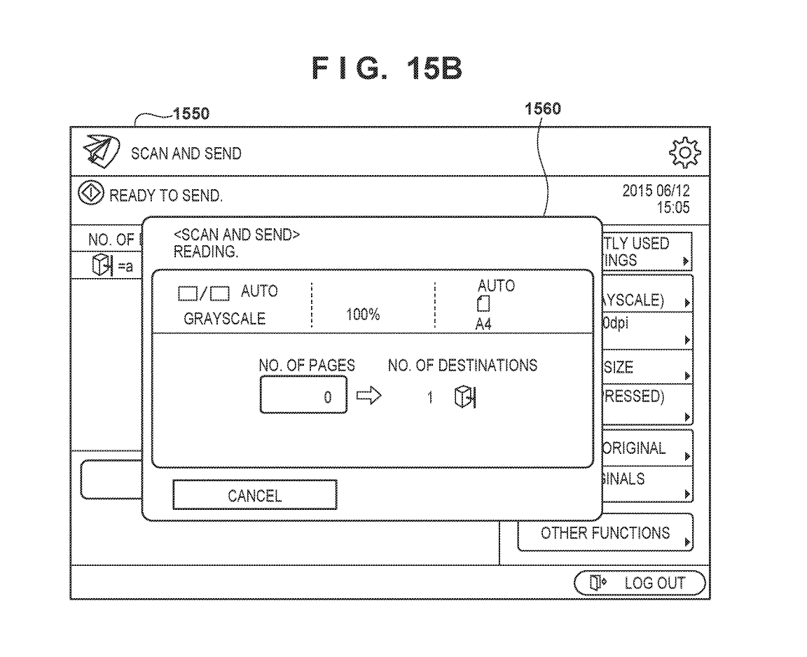

There are cases in which some sort of error (in the present example, an out-of-paper error) occurs during the execution of the copy job while the job execution dialogue 1420 is displayed by the copy control module 210. In such cases, the error recovery control module 215 that has detected a change in the job state generates an error recovery screen 1540 shown in FIG. 15A, for example, for recovering from the error, requests the display-operation control module 201 to activate itself, and displays the generated screen. Then, if a user completes the job by performing an operation to recover from the error or selects a job cancel button 1541, a transition is made to one of the custom menu screen 1401 shown in FIG. 14A and the copy screen 1410 shown in FIG. 14B. Here, one of these screens is decided on as a transition destination based on the settings configured on the custom menu screen 440 shown in FIG. 6B or the settings configured on the screen 1130 of “register with custom menu: settings at the time of calling” shown in FIG. 11A. The details of a method of deciding on a screen serving as a transition destination will be described later.

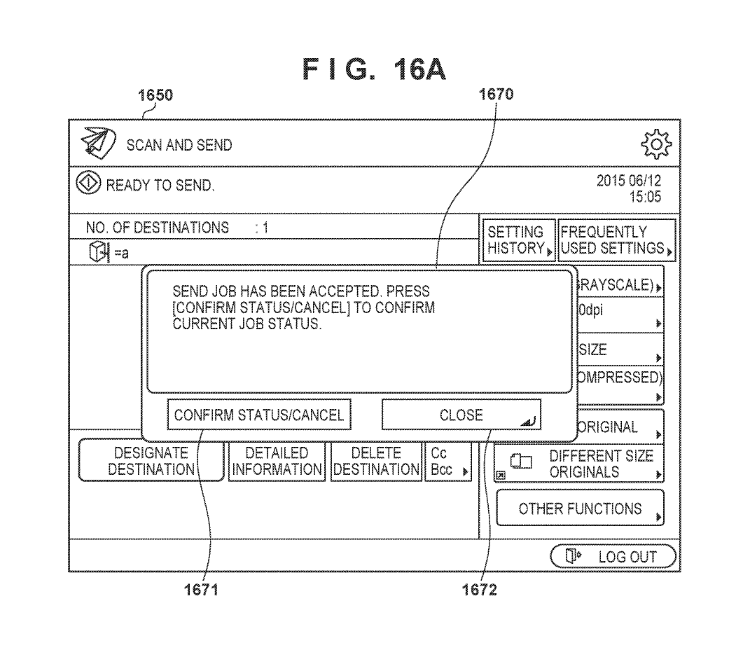

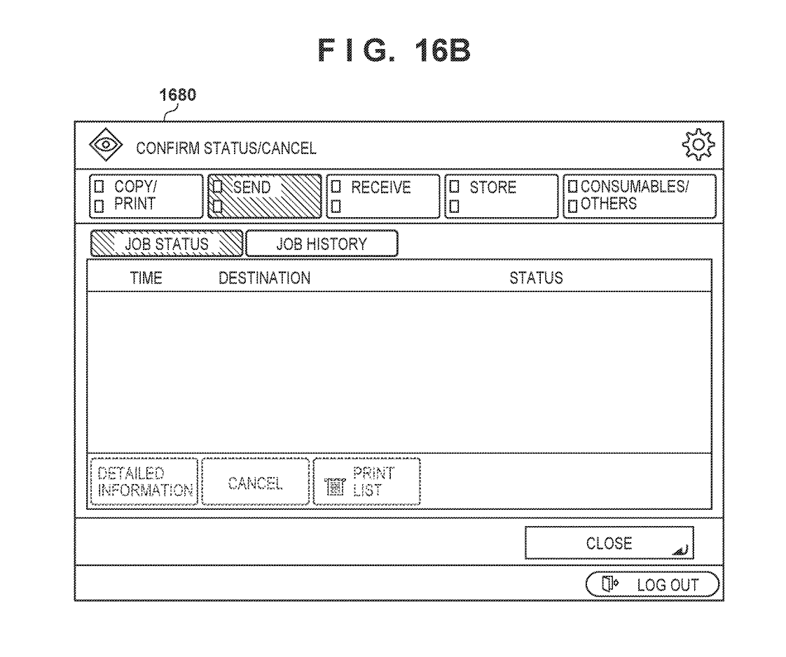

When the custom menu control module 212 has detected pressing of the custom button 1403 on the custom menu screen 1401 shown in FIG. 14A, it provides the send control module 211 with corresponding setting values, and requests the display-operation control module 201 to activate the send control module 211. As a result, a send screen 1550 shown in FIG. 15B is displayed on the display unit 119. In response to a request to start a send job, the send control module 211 displays a job execution dialogue 1560 on the send screen 1550 as shown in FIG. 15B, for example. Note that the send job is roughly composed of sheet reading processing and processing for sending read data. Therefore, completion of the sheet reading processing does not mark completion of the job. However, when sheet reading has been completed, some users may determine that the send job has been completed and leave the site of the MFP 101, whereas some users may observe until the completion of the send processing. In view of this, when the sheet reading processing has been completed, the send control module 211 makes an inquiry about whether to confirm the job status by displaying a confirmation dialogue 1670 on the send screen 1550 as indicated by screen 1650 in FIG. 16A, for example. Note that whether to display the confirmation dialogue 1670 may be freely changed by a user as a setting item corresponding to the send control module 211. When the send control module 211 has detected pressing of a button 1671 for confirmation of the job status, it requests the display-operation control module 201 to activate a screen generated by the job management control module 214. As a result, a screen 1680 shown in FIG. 16B, for example, is displayed on the display unit 119. At this time, although the return icon 408 is appended to the custom button 1403 shown in FIG. 14A, there is no return to the custom menu screen 1401 shown in FIG. 14A because a user has voluntarily designated a screen transition.

On the other hand, when the send control module 211 has detected selection of a close button 1672 on the screen 1650 shown in FIG. 16A, that is to say, no confirmation of the job state on the confirmation dialogue 1670, it requests the display-operation control module 201 to activate the custom menu control module 212. As a result, a transition is made to the custom menu screen 1401 shown in FIG. 14A. In the following description, the job execution dialogue 1420 is used as a collective term for the job execution dialogue 1420 shown in FIG. 14B and the job execution dialogue 1560 shown in FIG. 15B, no matter what the corresponding function is.

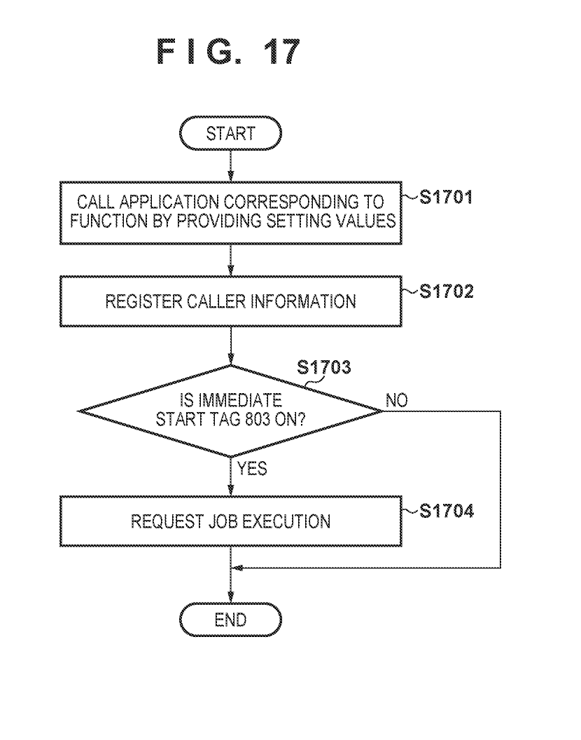

FIG. 17 is a flowchart for describing processing that is started when the MFP 101 according to the first embodiment has detected pressing of a custom button 405. As this processing is realized by the CPU 111 executing a program deployed from the ROM 113 or the external memory 120 to the RAM 112, it will be described herein as processing executed by the CPU 111.

First, in step S1701, the CPU 111 obtains setting values related to a pressed custom button 405 from the DB 206, and provides a function corresponding to the button (e.g., the copy control module 210 and the send control module 211) with the obtained setting values. When the CPU 111 has received, from the function, a notification indicating completion of generation of a screen reflecting the setting values, it requests the display-operation control module 201 to activate the function. As a result, an application corresponding to the function is initiated. Next, the processing proceeds to step S1702, and the CPU 111 references the successful termination tag 811 based on the obtained setting values of the function, and registers the custom menu control module 212 as caller information with the DB 206. Next, the processing proceeds to step S1703 and the CPU 111 determines whether or not the immediate start tag 803 in the obtained setting values is ON; in the case of ON, the processing proceeds to step S1704, and the CPU 111 requests a job execution, and ends the present processing. On the other hand, if the immediate start tag 803 is OFF, the processing is ended without starting the job execution.

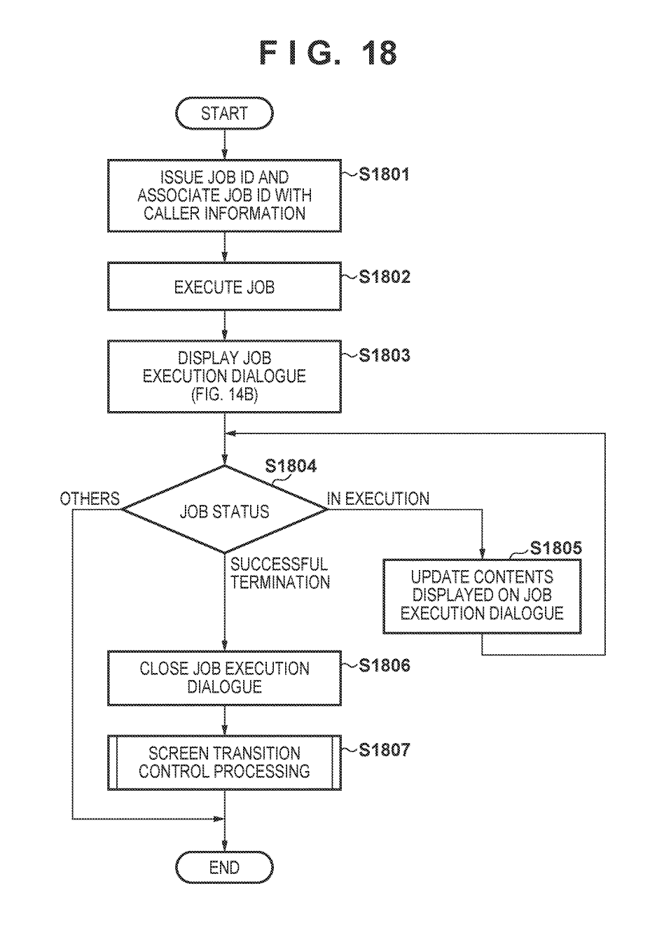

FIG. 18 is a flowchart for describing processing that is started when each function has received a job execution request in the MFP 101 according to the first embodiment. As this processing is realized by the CPU 111 executing a program deployed from the ROM 113 or the external memory 120 to the RAM 112, it will be described herein as processing executed by the CPU 111. Note that a job execution request is issued in step S1704 of FIG. 17, or issued by a corresponding function upon detection of pressing of a start key (not shown) on the touchscreen 118.

First, in step S1801, the CPU 111 functions as the job management control module 214 to issue a job ID of the corresponding function and store the issued job ID and caller information, in association with each other, to the DB 206. Next, the processing proceeds to step S1802, and the CPU 111 generates a job based on setting values, and executes the job. Next, the processing proceeds to step S1803 and the CPU 111 displays the job execution dialogue 1420 shown in FIG. 14B, for example.

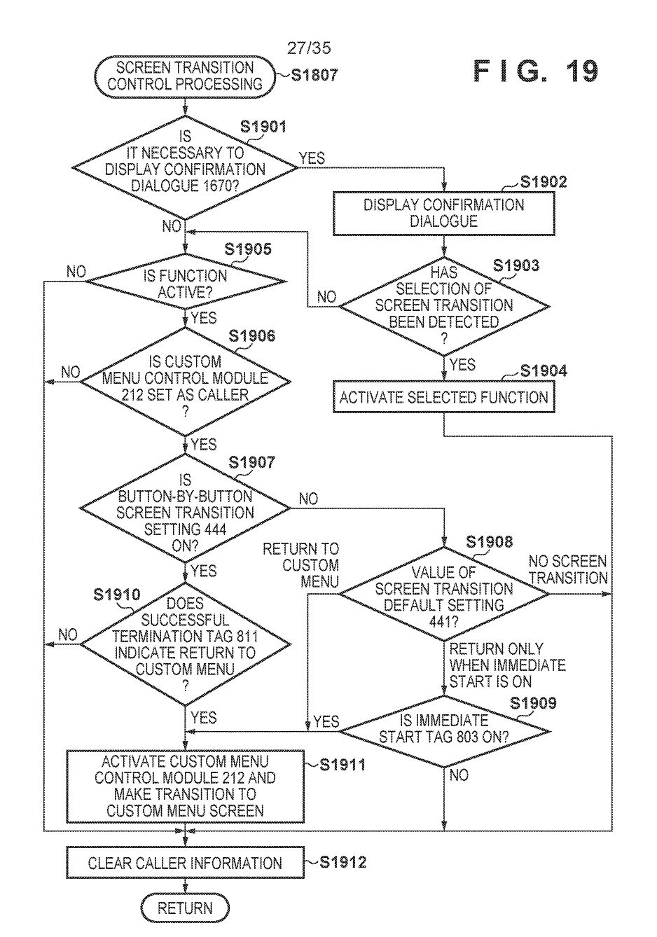

Next, the processing proceeds to step S1804 and the CPU 111 makes an inquiry to the job management control module 214 about the job status; if the job is in execution, the processing proceeds to step S1805, and the CPU 111 updates the contents displayed on the job execution dialogue 1420 shown in FIG. 14B, and the processing proceeds to step S1804. If the CPU 111 determines in step S1804 that the job status indicates successful termination, the processing proceeds to step S1806 and the CPU 111 closes the job execution dialogue 1420. Thereafter, the processing proceeds to step S1807, and the CPU 111 executes screen transition control processing, and displays a custom menu screen by activating the custom menu control module 212 or stays in the current function by closing the job execution dialogue 1420. This screen transition control processing in step S1807 will be described later with reference to a flowchart of FIG. 19. Note that in step S1804, if the job status indicates neither “successful termination” nor “in execution,” that is to say, if the job status indicates an error, for example, control is handed over to the later-described error recovery control module 215, and thus the processing is ended.

FIG. 19 is a flowchart for describing the screen transition control processing in step S1807 of FIG. 18.

First, in step S1901, the CPU 111 determines whether or not it is necessary to display the confirmation dialogue 1670 shown in FIG. 16A, for example. As mentioned earlier, this determination may be made based on setting values that are specific to functions, or may be adaptively made with reference to setting values of the job. If the CPU 111 determines that it is necessary to confirm the job status, the processing proceeds to step S1902 and the CPU 111 displays the confirmation dialogue 1670 on the display unit 119. In the next step S1903, when the CPU 111 has detected pressing of the status confirmation/cancel button 1671 or the close button 1672, that is to say, selection of a screen transition from the confirmation dialogue 1670, the processing proceeds to step S1904. In step S1904, the CPU 111 activates the selected function by requesting the display-operation control module 201 to activate the selected function. Then, the processing proceeds to step S1912, and the CPU 111 clears the caller information that was set in step S1702 of FIG. 17, and ends the processing.

On the other hand, if it is determined in step S1901 that the confirmation dialogue 1670 need not be displayed, or if the screen transition is not selected in step S1903, the processing proceeds to step S1905 and the CPU 111 determines whether or not the selected function is active by making an inquiry to the display-operation control module 201. If the result of the inquiry shows that the selected function is not active, it is determined that some sort of screen transition was made by a user operation or the system, and the processing proceeds to step S1912. In step S1912, the CPU 111 clears the caller information without activating the custom menu control module 212, and ends the processing.

On the other hand, if the selected function is determined to be active in step S1905, the processing proceeds to step S1906, and the caller information that was registered with the DB 206 in step S1702 of FIG. 17 is referenced to confirm setting values thereof. Also, the CPU 111 determines whether or not the custom menu control module 212 is set as the caller information. If so, the processing proceeds to step S1907, and screen transition control is handed over to the custom menu control module 212. On the other hand, if the custom menu control module 212 is not set as the caller information, the processing proceeds from step S1906 to step S1912 without activating the custom menu control module 212.

In step S1907, the CPU 111 determines whether or not a value of the button-by-button screen transition setting 444 shown in FIG. 6B is ON. If the value is determined to be ON, the processing proceeds to step S1910, and a value of the successful termination tag 811 (FIG. 8) linked to the job is confirmed. In step S1910, the CPU 111 determines whether or not the successful termination tag 811 is set to “return to custom menu;” if so, the processing proceeds to step S1911, and the CPU 111 requests the display-operation control module 201 to activate the custom menu control module 212, and the processing proceeds to step S1912. On the other hand, if the successful termination tag 811 is not set to “return to custom menu,” the processing proceeds to step S1912 without activating the custom menu control module 212.

If the CPU 111 determines in step S1907 that the button-by-button screen transition setting 444 shown in FIG. 6B is OFF, the processing proceeds to step S1908 to make a screen transition based on the screen transition default setting 441 shown in FIG. 6B, and the CPU 111 confirms a setting value thereof. The processing proceeds to step S1911 and step S1912 if the screen transition default setting 441 is “return to custom menu” 601 and “no screen transition” 603, respectively. The processing proceeds to step S1909 if the screen transition default setting 441 is “return only when immediate start is ON” 602. In step S1909, the CPU 111 causes the caller function to issue a notification indicating a value of the immediate start tag 803 shown in FIG. 8, and determines whether or not the value of the immediate start tag 803 is ON. The processing proceeds to step S1911 if the value is determined to be ON, and to step S1912 if the value is determined to be OFF.

The procedure that has been elaborated thus far with reference to the flowcharts of FIGS. 18 and 19 enables control to return to the menu screen, or make no screen transition, upon successful termination of a job.

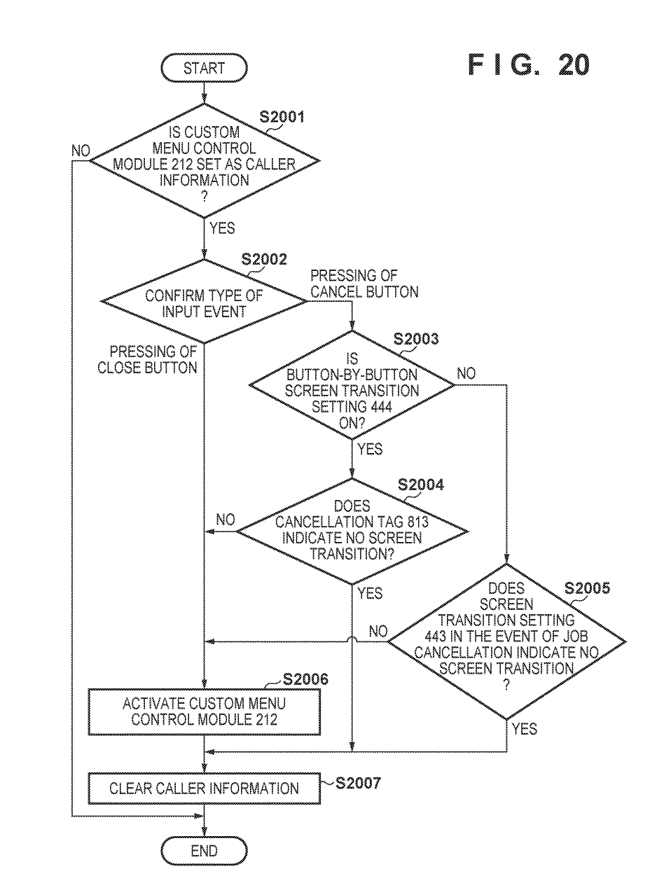

FIG. 20 is a flowchart for describing processing that is started when the MFP 101 according to the first embodiment has detected some sort of input while the job execution dialogue 1420 shown in FIG. 14B, for example, is displayed. As this processing is realized by the CPU 111 executing a program deployed from the ROM 113 or the external memory 120 to the RAM 112, it will be described herein as processing executed by the CPU 111.

First, in step S2001, the CPU 111 obtains caller information from the DB 206, and determines whether or not the custom menu control module 212 is set as the caller information. If it is determined that the custom menu control module 212 is not set as the caller information, the processing is ended without making a screen transition. On the other hand, if the CPU 111 determines in step S2001 that the custom menu control module 212 is set as the caller information, the processing proceeds to step S2002 and the CPU 111 confirms the type of an input event indicated by a notification from the display-operation control module 201. If the type of the input event is pressing of the close button 1422, it is determined that a corresponding job has been successfully terminated, and the processing proceeds to step S2006 in which the display-operation control module 201 is requested to activate the custom menu control module 212. As a result, the custom menu screen 1401 shown in FIG. 4A, for example, is displayed on the display unit 119, and the processing proceeds to step S2007.

On the other hand, if the CPU 111 determines that the type of the input event is pressing of the cancel button 1421, the processing proceeds to step S2003 and the CPU 111 makes an inquiry to the custom menu control module 212 about a setting value of the button-by-button screen transition setting 444 shown in FIG. 6B. In step S2003, the CPU 111 determines whether or not the button-by-button screen transition setting 444 is ON; if so, the processing proceeds to step S2004 and the CPU 111 determines whether or not a setting value of the cancellation tag 813 shown in FIG. 8, which is included among setting values provided by the custom menu control module 212, is “no screen transition.” If the setting value is determined to be “no screen transition,” the processing proceeds to step S2007 without activating the custom menu control module 212; if not, in the next step S2006, a transition is made to the custom menu screen 1401, and the processing proceeds to step S2007.

If the CPU 111 determines in step S2003 that the button-by-button screen transition setting 444 is OFF, the processing proceeds to step S2005, and the CPU 111 requests the custom menu control module 212 for a setting value of the screen transition setting 443 in the event of job cancellation (FIG. 6B), and confirms the setting value. If the screen transition setting 443 in the event of job cancellation is “no screen transition” in step S2005, the processing proceeds to step S2007 without activating the custom menu control module 212, and the CPU 111 clears the caller information, and ends the processing. On the other hand, if the value of the cancellation tag 813 is not “no screen transition,” the processing proceeds to step S2006, and the CPU 111 activates the custom menu control module 212, and displays the custom menu screen 1401 on the display unit 119. In the next step S2007, the caller information is cleared, and then the processing is ended.

A screen transition associated with input to the job execution dialogue 1420 shown in FIG. 14B is realized based on the foregoing processing procedure.

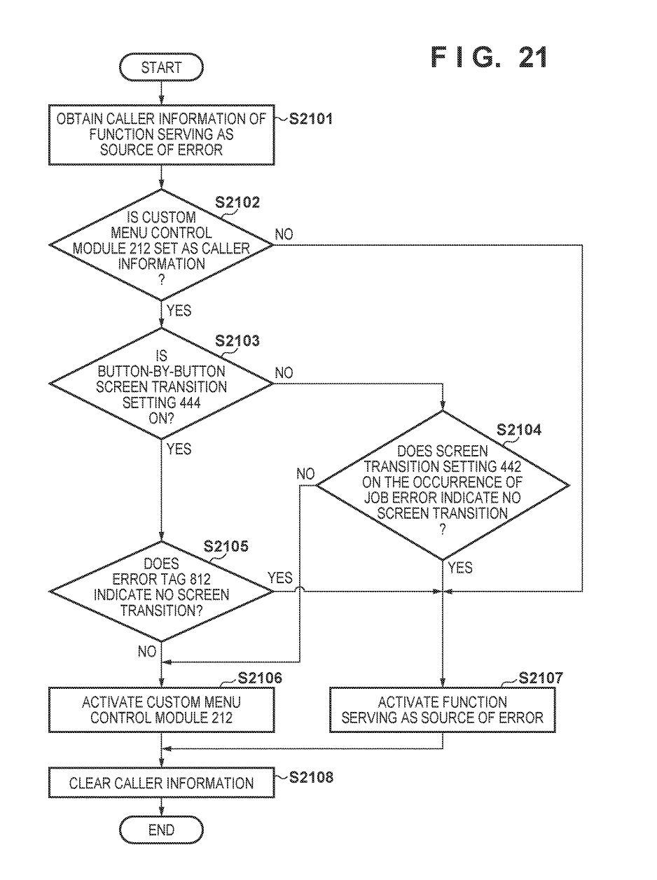

FIG. 21 is a flowchart for describing processing that is executed by the MFP 101 according to the first embodiment when error recovery or the job cancel button 1541 is designated by a user operation while the error recovery screen 1540 shown in FIG. 15A, for example, is displayed. As this processing is realized by the CPU 111 executing a program deployed from the ROM 113 or the external memory 120 to the RAM 112, it will be described herein as processing executed by the CPU 111.

Here, the CPU 111 functions as the error recovery control module 215, and first obtains a job ID and the function tag 802 (FIG. 8) from a job that is currently undergoing an error in step S2101. Then, it obtains caller information linked to the job ID by requesting a function serving as a source of the error for the caller information. Next, the processing proceeds to step S2102 and the CPU 111 determines whether or not the custom menu control module 212 is set as the caller information. If the custom menu control module 212 is not set as the caller information, the processing proceeds to step S2107, and the CPU 111 requests the display-operation control module 201 to activate the function serving as the source of the error, and the processing proceeds to step S2108. In step S2108, the CPU 111 clears the caller information that is managed while linked to the job ID of the job, and ends the processing.

On the other hand, if the CPU 111 determines in step S2102 that the custom menu control module 212 is set as the caller information, the processing proceeds to step S2103 and the CPU 111 requests the custom menu control module 212 for a setting value of the button-by-button screen transition setting 444 shown in FIG. 6B. Then, the CPU 111 determines whether or not the button-by-button screen transition setting 444 is ON. If the CPU 111 determines that the button-by-button screen transition setting 444 is ON, the processing proceeds to step S2105, and the CPU 111 references the error tag 812 shown in FIG. 8 linked to the job that is currently undergoing the error, and determines whether or not this tag is set to “no screen transition.” If this tag is set to “no screen transition,” the processing proceeds to step S2107, and the CPU 111 requests the display-operation control module 201 to activate the function serving as the source of the error, and the processing proceeds to step S2108.

On the other hand, if the CPU 111 determines in step S2105 that the error tag 812 is set to “return to custom menu,” the processing proceeds to step S2106 and the CPU 111 requests the display-operation control module 201 to activate the custom menu control module 212. As a result, the custom menu screen 1401 is displayed on the display unit 119, and the processing proceeds to step S2108.

If the CPU 111 determines in step S2103 that the button-by-button screen transition setting 444 is OFF, the processing proceeds to step S2104, and the CPU 111 requests the custom menu control module 212 for a setting value of the screen transition setting 442 on the occurrence of job error (FIG. 6B), and confirms the setting value. If the screen transition setting 442 on the occurrence of job error is “no screen transition” in step S2104, the processing proceeds to step S2107. In step S2107, the CPU 111 requests the display-operation control module 201 to activate the function serving as the source of the error without returning to the custom menu control module 212, and the processing proceeds to step S2108. On the other hand, if it is determined in step S2104 that the setting is “return to custom menu,” the processing proceeds to step S2106, the display-operation control module 201 is requested to activate the custom menu control module 212, and then the processing proceeds to step S2108.

A screen transition associated with input to the error recovery control module 215 is realized based on the foregoing processing procedure.

Note that the present flowchart is started at the initiation of an error recovery operation during the execution of the job, and it is determined that the error has occurred, with reference to the screen transition setting 442 on the occurrence of job error or the error tag 812, both when error recovery has been successfully accomplished and when the job has been cancelled. Alternatively, when error recovery has been successfully accomplished, the error may be deemed non-existent, and error recovery may be followed by a return to the custom menu control module 212. Alternatively, in the case of job cancellation, the job may be deemed cancelled, rather than an error, and a screen transition may be controlled with reference to the screen transition setting 443 in the event of job cancellation or the cancellation tag 813.

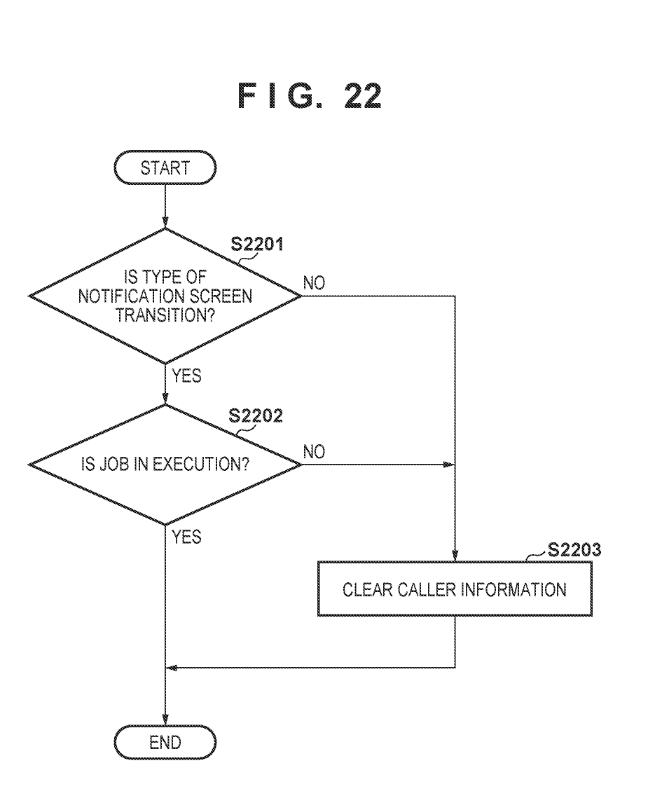

FIG. 22 is a flowchart for describing processing that is started upon receiving a predetermined notification from the display-operation control module 201 or the authentication control module 202 in the MFP 101 according to the first embodiment. Here, the predetermined notification is received, for example, upon deactivation of the display-operation control module 201, or upon issuance of a logout notification from the authentication control module 202. As this processing is realized by the CPU 111 executing a program deployed from the ROM 113 or the external memory 120 to the RAM 112, it will be described herein as processing executed by the CPU 111.

First, in step S2201, when the CPU 111 has received the predetermined notification, it determines whether or not the type of the notification is based on a screen transition. If the type of the notification is not determined to be a screen transition, for example, if the type of the notification is determined to be a logout, the processing proceeds to step S2203, caller information is cleared, and then the processing is ended. This prevents a transition to the menu screen caused by inadvertent activation of the custom menu control module 212 during the display of an authentication screen (not shown) generated by the authentication control module 202.

On the other hand, if the CPU 111 determines in step S2201 that the type of the notification is based on a screen transition, the processing proceeds to step S2202 and the CPU 111 determines whether or not a job is in execution. If the CPU 111 determines that a job is not in execution, the processing proceeds to step S2203, and the CPU 111 clears the caller information, and ends the processing. If the CPU 111 determines in step S2202 that a job is in execution, it ends the processing without clearing the caller information.

The foregoing processing is based on the assumption that, during the display of the job execution dialogue 1420 after, for example, a user started a copy job by pressing the custom button 1402 (FIG. 14A) of the copy control module 210, a transition is made to the status confirmation screen 1680 shown in FIG. 16B, for example, to confirm the status of the copy job. Thereafter, if the job is still in execution upon returning from the status confirmation screen 1680 to the copy control module 210, the job execution dialogue 1420 shown in FIG. 14B will be continuously displayed. Thereafter, if the copy job is successfully terminated, the process of step S1806, which has been described with reference to the flowchart of FIG. 18, and the subsequent processes will be executed, and completion of these processes will be followed by a return to the custom menu control module 212. That is to say, after a transition is made to another screen during the execution of a job associated with pressing of the custom button 1402 shown in FIG. 14A, a return to a function related to the job is accompanied by a return to the custom menu control module 212. However, such control may not be performed; when some sort of screen transition has been made, the screen transition may not always be followed by a return to the custom menu control module 212. In this case, it is sufficient to always clear the caller information upon receiving the predetermined notification.

Control over the caller information based on the foregoing processing procedure realizes control as to whether to appropriately activate the custom menu control module 212, that is to say, whether to return to the custom menu screen.

As described above, in the first embodiment, after a transition is made to a screen of a desired function by pressing a custom button registered with the image forming apparatus, an automatic transition to the custom menu screen can be made if the started job is successfully terminated. Therefore, in a case where a user sequentially presses a plurality of custom buttons that have been registered in association with routine tasks, the user need not perform an operation to return to the custom menu screen each time; this can make the tasks efficient.

Furthermore, the first embodiment enables a configuration in which an automatic transition to the custom menu screen is made each time a custom button is pressed.

After a user has pressed a custom button, any change in settings on a copy screen reflecting the settings of the custom button is followed by a return to the custom menu screen. In this case, it is necessary to re-generate the custom button by re-inputting setting values from the start; this increases the burden on the user and lowers user-friendliness. In view of this, in the first embodiment, whether to return to the custom menu screen can be set for each custom button. This enables the following configuration: after a user has made a transition to a screen of a desired function by pressing a custom button and executed a corresponding job, the function is continuously displayed to enable a change in the settings of the function without returning to the custom menu screen, and another job can be executed in accordance with the changed setting values.

The first embodiment also enables a configuration in which an automatic return to the custom menu screen is made only when a job is started immediately upon pressing of a custom button by a user. This can save the user the trouble of setting a screen transition for each custom button.

Furthermore, in the first embodiment, a custom button for which an automatic return to the custom menu screen is set is displayed with the return icon 408 appended thereto. Therefore, a user can determine in one glance whether the execution of a job associated with the custom button is followed by a return to the custom menu screen. This makes it possible to determine, in advance, whether a screen transition caused by pressing of the custom button complies with the user's intention; in other words, improved usability is offered to the user.

Furthermore, the first embodiment enables a setting of whether to return to the custom menu screen when a job that has been started by pressing a custom button is suspended due to an error or cancellation. This can prevent a situation in which a function serving as a source of the error cannot be identified due to an automatic return to the custom menu screen on the occurrence of the error.

Meanwhile, with regard to an error that commonly occurs, such as an out-of-paper error and an out-of-toner error, a job can be successfully terminated by loading sheets and toner in spite of such an error, and hence a return to the custom menu screen can be set. Furthermore, for example, the following configuration can be adopted: when a print job linked to a custom button is cancelled during the execution of the print job to change a setting related to the number of copies to be printed, the cancellation is not followed by a return to the custom menu screen. In this way, the job can be continuously executed with the changed setting.

In the foregoing description of the first embodiment, a screen transition begins upon pressing of a custom button on the custom menu screen. However, it should be noted that the first embodiment is also applicable to a screen transition that begins upon pressing of the copy button 330 and the scan and send button 331 on the main menu screen area 301 shown in FIG. 3A, for example.

As described above, the first embodiment can solve a problem faced by a user who wants to make tasks efficient by making use of custom buttons, that is to say, a problem whereby the user needs to perform an operation to make a transition to the menu screen each time after completion of a job associated with a custom button. In other words, the first embodiment realizes the following configuration: after a transition is made to a screen of a desired function by pressing a custom button, successful termination of a job related to the custom button is automatically followed by a return to the custom menu screen.

On the other hand, when a user has performed an operation that accompanies a screen transition during the execution of a job that the user started by pressing a custom button, the screen transition is not followed by a return to the custom menu screen if the job execution is completed without returning to a pre-transition screen. In this way, hindrance to operations caused by a transition to the custom menu screen can be prevented, for example, when the user has made a screen transition to use another function, or when the user has opened a setting screen to change various settings of the image forming apparatus.

As described above, in the first embodiment, the execution of processing linked to a custom button is automatically followed by a return to the custom menu screen, and thus improved usability can be offered to a user. When the user does not want to return to the custom menu screen, screen transition settings of custom buttons can be configured to that effect so as to avoid an automatic return to the custom menu screen.

### Second Embodiment

A second embodiment of the present invention will now be described. In the following description of the second embodiment, processing for a screen transition upon successful termination of a job is executed by the display-operation control module 201 instead of a function. Note that the configuration of the MFP according to the second embodiment is similar to that according to the above-described first embodiment, and thus a description thereof will be omitted. Specifically, the hardware and software configurations, flowcharts, and sequences of actions according to the above-described first embodiment, which have been described with reference to FIGS. 1 to 17 and FIGS. 19 to 22, are shared in common with the second embodiment. The second embodiment additionally includes processing associated with a job execution start request and screen transition processing that is executed by the display-operation control module 201 based on a job status transition.

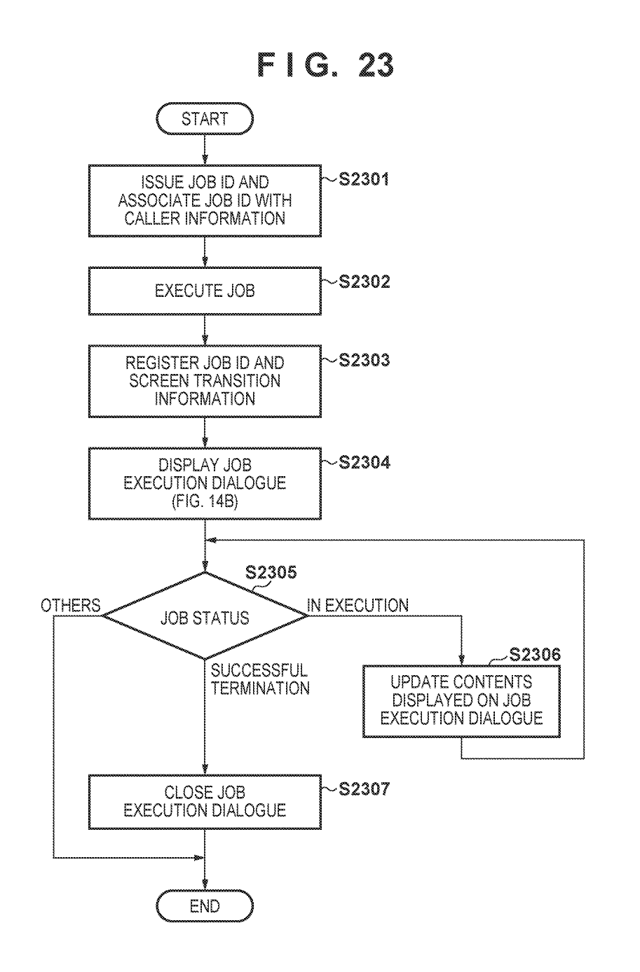

FIG. 23 is a flowchart for describing processing that is started when the MFP 101 according to the second embodiment of the present invention has received a job execution request. As this processing is realized by the CPU 111 executing a program deployed from the ROM 113 or the external memory 120 to the RAM 112, it will be described herein as processing executed by the CPU 111.

The flowchart of FIG. 23 corresponds to the flowchart of FIG. 18 according to the above-described first embodiment; specifically, steps S2301 to S2302 and steps S2304 to S2307 correspond to the above-described steps S1801 to S1806 of FIG. 18. Therefore, in FIG. 23, step S2303 is added and step S1807 of FIG. 18 is eliminated.

In step S2303, the CPU 111 requests the display-operation control module 201 to register a pair of the job ID issued in step S2301 and the successful termination tag 811 (FIG. 8). In response to the request, the display-operation control module 201 registers the pair with the DB 206.

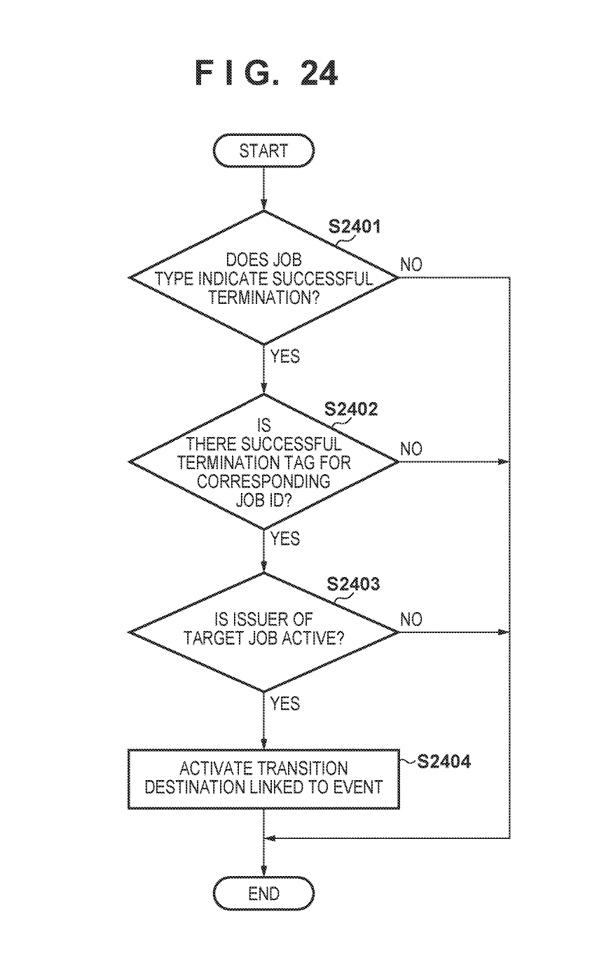

FIG. 24 is a flowchart for describing processing that is executed by the MFP 101 according to the second embodiment along with a change in a job state. As this processing is realized by the CPU 111 executing a program deployed from the ROM 113 or the external memory 120 to the RAM 112, it will be described herein as processing executed by the CPU 111.

First, in step S2401, the CPU 111 functions as the display-operation control module 201, and determines whether or not a job state indicated by a notification from the job management control module 214 is successful termination. If the job state is not determined to be successful termination, the processing is ended. On the other hand, if the job state is determined to be successful termination in step S2401, the processing proceeds to step S2402. In step S2402, the CPU 111 determines whether or not there is a successful termination tag 811 for an ID of a corresponding job. If there is no such successful termination tag 811, the processing is ended. If the CPU 111 determines in step S2402 that there is such a successful termination tag 811, the processing proceeds to step S2403, and the CPU 111 obtains a function that issued the job from the job, and determines whether or not the function is active. If the function is not determined to be active, the processing is ended. On the other hand, if the function is determined to be active, the processing proceeds to step S2404 and the CPU 111 activates a predetermined function based on information registered with the successful termination tag 811 and the processing is ended.

At this time, in the second embodiment, the custom menu control module 212 is activated to make a transition to the custom menu screen. Alternatively, the main menu control module 213 or a different menu function can be designated.

As described above, the second embodiment enables the following configuration: after a transition is made to a screen of a desired function by pressing a custom button registered with the image forming apparatus, successful termination of the started job is automatically followed by a transition to the custom menu screen. Note that the second embodiment differs from the first embodiment in that the display-operation control module 201 adaptively activates a desired function along with a change in a job state. This eliminates the need to implement screen transition control upon successful termination of a job on a per-function basis. Therefore, in the case of functions linked to the custom menu control module 212, a transition to the custom menu screen can be automatically made in coordination with a change in a job state.

In this way, usability provided by the MFP stays consistent, and thus improved convenience can be offered to a user.

### Third Embodiment

In the following description of a third embodiment, screen settings via the screens shown in, for example, FIGS. 6B and 11A according to the first embodiment are not configured. Note that the configuration of the MFP according to the third embodiment is similar to that according to the above-described first embodiment, and thus a description thereof will be omitted.

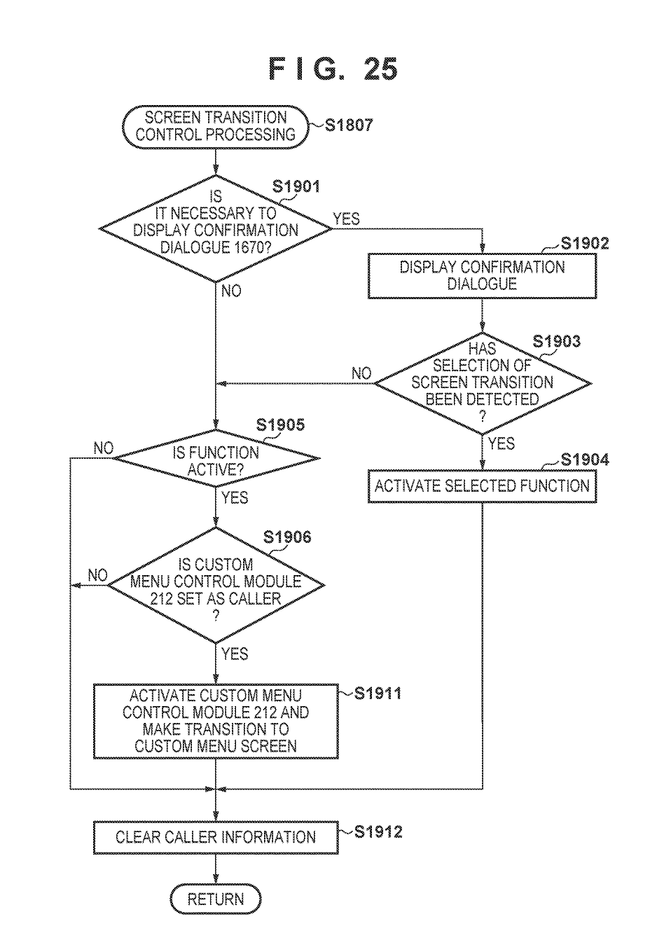

FIG. 25 is a flowchart for describing the screen transition control processing in step S1807 of FIG. 18 according to the third embodiment. Note that the flowchart of FIG. 25 is obtained by eliminating the determination processes in steps S1907 to S1910 from the above-described flowchart of FIG. 19; thus, the processes that are the same as those in FIG. 19 are given the same reference signs thereas, and a description thereof will be omitted.

In FIG. 25, if the CPU 111 determines in step S1906 that the caller is the custom menu control module 212, the processing proceeds to step S1911 and the CPU 111 makes a transition from a function screen (e.g., a screen of a copy application) to the custom menu screen. On the other hand, if it is determined in step S1906 that the caller is not the custom menu control module 212, for example, if a function has been called from the main menu screen, a screen transition is not made, that is to say, the function screen is continuously displayed.

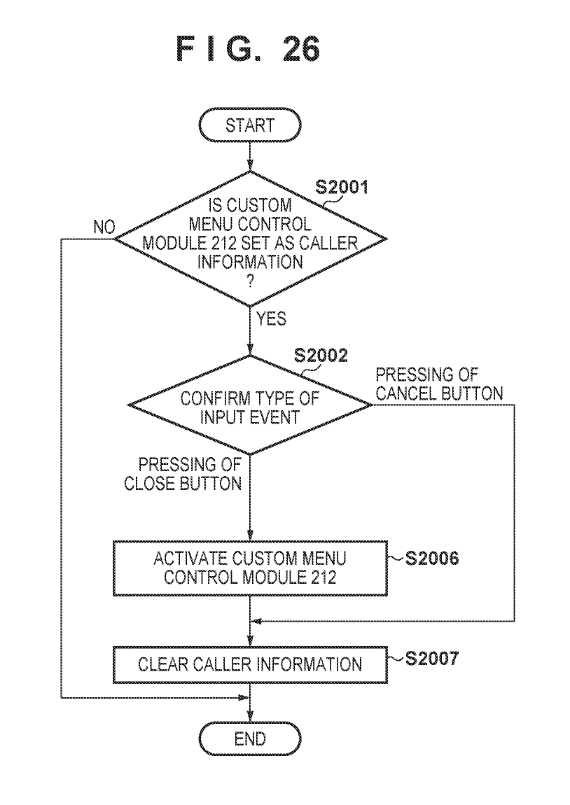

FIG. 26 is a flowchart for describing processing that is started when the MFP 101 according to the third embodiment has detected some sort of input while the job execution dialogue 1420 shown in FIG. 14B, for example, is displayed. Note that the flowchart of FIG. 26 is obtained by eliminating the determination processes in steps S2003 to S2005 from the above-described flowchart of FIG. 20; thus, the processes that are the same as those in FIG. 20 are given the same reference signs thereas, and a description thereof will be omitted.

Referring to FIG. 26, in step S2002, the CPU 111 confirms the type of an input event indicated by a notification from the display-operation control module 201. If the type of the input event is pressing of the close button 1422, it is determined that a corresponding job has been successfully terminated, and the processing proceeds to step S2006 in which the display-operation control module 201 is requested to activate the custom menu control module 212. As a result, the custom menu screen 1401 shown in FIG. 4A, for example, is displayed on the display unit 119, and the processing proceeds to step S2007.

On the other hand, if the type of the input event is determined to be pressing of the cancel button 1421, the processing proceeds to step S2007 without making a screen transition, that is to say, a function screen is continuously displayed.

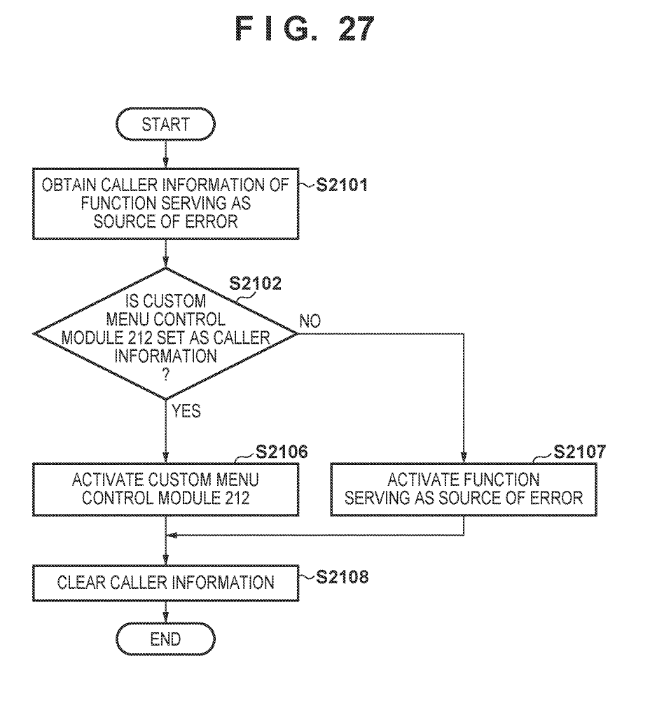

FIG. 27 is a flowchart for describing processing that is executed by the MFP 101 according to the third embodiment when error recovery or the job cancel button 1541 is designated by a user operation while the error recovery screen 1540 shown in FIG. 15A, for example, is displayed. Note that the flowchart of FIG. 27 is obtained by eliminating the determination processes in steps S2103 to S2105 from the above-described flowchart of FIG. 21; thus, the processes that are the same as those in FIG. 21 are given the same reference signs thereas, and a description thereof will be omitted.

In step S2102, the CPU 111 determines whether or not the custom menu control module 212 is set as the caller information. If the custom menu control module 212 is not set as the caller information, the processing proceeds to step S2107, and the CPU 111 requests the display-operation control module 201 to activate the function serving as the source of the error, and the processing proceeds to step S2108.

On the other hand, if the CPU 111 determines in step S2102 that the custom menu control module 212 is set as the caller information, the processing proceeds to step S2106, and the CPU 111 requests the display-operation control module 201 to activate the custom menu control module 212, displays the custom menu screen, and the processing proceeds to step S2108.

As described above, the third embodiment enables the following configuration: when a job has been successfully terminated, the successful termination is followed by a return to the original menu screen if the caller is the custom menu, and a function screen is continuously displayed if the caller is not the custom menu. This can solve a problem faced by a user who wants to make tasks efficient by making use of custom buttons, that is to say, a problem whereby the user needs to perform an operation to make a transition to the menu screen each time after completion of a job associated with a custom button. On the other hand, when a user has performed an operation that accompanies a screen transition during the execution of a job that the user started by pressing a custom button, the screen transition is not followed by a return to the custom menu screen if the job execution is completed without returning to a pre-transition screen. In this way, hindrance to operations caused by a transition to the custom menu screen can be prevented, for example, when the user has made a screen transition to use another function, or when the user has opened a setting screen to change various settings of the image forming apparatus.

### Other Embodiment

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments.

This application claims the benefit of Japanese Patent Application No. 2015-184320, filed Sep. 17, 2015, which is hereby incorporated by reference herein in its entirety.

What is claimed is:

1. A display control method in an image processing apparatus capable of executing a plurality of functions, the method comprising:
a display step of displaying a custom menu screen for causing a user to select a custom button corresponding to any one of the plurality of functions;
a first transition step of making a transition to an application screen for executing a function corresponding to a custom button selected by the user in accordance with a selection of the custom button via the custom menu screen; and
a second transition step of making a transition to the custom menu screen in response to a completion of an execution of a job related to the function.

2. The display control method according to claim 1, wherein in the second transition step, making a transition to the custom menu screen if the application screen is displayed when the execution of the job is completed, and a display of the another screen is maintained without making a transition to the custom menu screen if another screen being different from the application screen is displayed when the execution of the job is completed.

3. The display control method according to claim 1, further comprising:
a second display step of displaying a main menu screen for causing a user to select a function of the plurality of functions;
a third transition step of making a transition to an application screen corresponding to a function selected by the user via the main menu screen;
a determination step of determining whether the application screen is made a transition from the custom menu screen or from the main menu screen; and
a control step of controlling to make a transition to the custom menu screen or to maintain the application screen upon completing an execution of a job related to the function in accordance with a determination result by the determination step.

4. The display control method according to claim 3, wherein in the control step, in a case that it is determined in the determination step that the application screen is made a transition from the custom menu screen, making a transition to the custom menu screen upon completing the execution of the job related to the function, and
in a case that it is determined in the determination step that the application screen is made a transition from the main menu screen, maintaining a display of the application screen upon completing the execution of the job related to the function.

5. The display control method according to claim 1, further comprising:
a third display step of displaying a confirmation dialogue for inquiring whether or not a user to confirm an execution status of the job during execution of the job;
a fourth transition step of making a transition to an execution status confirmation screen for displaying the execution status of the job in a case that the user designates to confirm the execution status of the job via the confirmation dialogue, and not making a transition to the custom menu screen upon completing the execution of the job in a case of making a transition to the execution status confirmation screen.

6. The display control method according to claim 1, wherein the any one function and a setting value related to the any one function are registered in correspondence with the custom button, and
the first transition step displays the application screen by reading out the setting value registered in correspondence with the custom button.

7. The display control method according to claim 1, wherein the plurality of functions include at least one of a copy function for printing based on image data generated by reading an image on an original, a send function for sending image data generated by reading an image on an original to an external device, and a print function for printing based on image data received from an external device.

8. An image processing apparatus capable of executing a plurality of functions, the apparatus comprising:
a display unit configured to display a custom menu screen for causing a user to select a custom button corresponding to any one of the plurality of functions;
a first transition unit configured to make a transition to an application screen for executing a function corresponding to a custom button selected by the user in accordance with a selection of the custom button via the custom menu screen; and
a second transition unit configured to make a transition to the custom menu screen in response to a completion of an execution of a job related to the function.

9. A non-transitory computer-readable storage medium storing a program for causing a computer to perform a display control method in an image processing apparatus capable of executing a plurality of functions, the method comprising:
displaying a custom menu screen for causing a user to select a custom button corresponding to any one of the plurality of functions;
making a transition to an application screen for executing a function corresponding to a custom button selected by the user in accordance with a selection of the custom button via the custom menu screen; and
making a transition to the custom menu screen in response to a completion of an execution of a job related to the function.
